(19) United States
(12) Patent Application Publication
(10) Pub. No.: US 2002/0126332 A1
(43) Pub. Date: Sep. 12, 2002

(54) System and method for modulating light intesity

(76) Inventor: Milan M. Popovich, Leicester (GB)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 09/956,303

(22) Filed: Sep. 19, 2001

Related U.S. Application Data
(63) Continuation-in-part of application No. 09/418,731, filed on Oct. 15, 1999, now abandoned.
Application No. 09/418,731 is a continuation-in-part of application No. 09/312,911, filed on May 17, 1999, now abandoned.
(60) Provisional application No. 60/100,167, filed on Sep. 14, 1998.
(60) Provisional application No. 60/103,433, filed on Oct. 6, 1998.
(60) Provisional application No. 60/104,616, filed on Oct. 16, 1998.

(51) Int. Cl. G03H 1/26; G03B 21/00; G03H 1/00; G02B 5/32

(52) U.S. Cl. 359/15; 359/1

(57) ABSTRACT

The present invention relates to a light intensity modulator that employs a hologram. In one embodiment, the light intensity modulator includes an electrical circuit and a holographic optical element containing the hologram. The holographic optical element is electrically coupled to and receives a variable voltage generated by the electric circuit. Additionally, the holographic optical element receives an input light from a light source. The holographic optical element receives and diffracts the input light to produce first and second output lights. An intensity of the first output light varies directly with the magnitude of the voltage. An intensity of the second output light varies indirectly with the magnitude of the voltage. The first and second output lights define a non-zero angle therebetween.

### RELATED APPLICATIONS

The present application claims benefit of U.S. Provisional Application Serial No. 60/104,616 filed Oct. 16, 1998, and is a continuation-in-part of prior application Ser. No. 09/418,731, filed Oct. 15, 1999, which is a continuation-in-part application of U.S. application Ser. No. 09/312,911 filed May 17, 1999, which claims the benefit of U.S. Provisional Application Serial No. 60/100,167 filed on Sep. 14, 1998, and U.S. Provisional Application Serial No. 60/103,433 filed Oct. 6, 1998.

### BACKGROUND OF THE INVENTION

1. Field of the Invention

The present invention relates generally to light intensity modulators, and more particularly to light intensity modulators employing holograms.

2. Description of the Relevant Art

Spatial light modulators (SLMS) and light intensity modulators (LIMs) are devices generating light with a modulated intensity. There are several types of light modulators in the prior art. Common types include electromechanical shutters, acousto-optic modulators, and electro-optic modulators. The electromechanical shutters typically use an electric motor or actuator to move an opaque member in or out of the light's path. The acousto-optic modulator diffracts light using a sound wave travelling through a transparent solid. The electro-optic modulators use the effect of electrically induced refractive index changes to modulate polarized light.

The varying characteristics of these modulator technologies gives each certain advantages and disadvantages. The electromechanical modulators have perfect optical characteristics, passing all incident light without alteration in their open state, and completely stopping all incident light in their closed state. They have the disadvantages of relatively slow switching time (typically not faster than a few milliseconds) and high switching energy Further, electromechanical modulators capable of independently controlling selected parts of their aperture are possible in principle, but difficult in practice because of their complexity and poor reliability. The acousto-optic modulators are much faster (typical bandwidths of many MHz) and more reliable than mechanical modulators, but they also require high power requirements (typically 1 watt) to operate. The electro-optic modulators can also be quite fast, while consuming less power when compared to acousto-optic modulators. Electro-optic modulators are often constructed by placing electrode adjacent to a liquid crystal material. This principle is used to make the well-known liquid crystal displays. Liquid crystal displays rely on the bulk properties of the liquid crystal material to achieve light intensity modulation. The liquid crystal material can be seen as having two components of refractive index. In operation, an electric field is applied to the liquid crystal molecule structure, which changes the difference between the two refractive indices. The change between the two refractive indices causes light components traveling in different directions to go through the liquid crystal material at different speeds. Unfortunately, the liquid crystal structure is slow to change its properties in response to a change of the electric field applied thereto when the speed of the liquid crystal response is compared to the speed at which the electric field is changed. As a result, liquid crystal displays employing conventional LIMs have limited refresh rates.

Further, conventional liquid crystal displays relying on the bulk properties of liquid crystals are limited in their ability to produce modulated light of acceptable intensity. Liquid crystal displays employing liquid crystal droplets embedded in a polymer matrix modulate light by means of a diffraction pattern comprising alternate bands of clear polymer and polymer populated by liquid crystal droplets. The diffraction efficiency suitable for image display purposes generally require the LIM to be relatively thick enough that the incident light encounters a sufficient number of randomly oriented liquid crystal droplets. However, the speed at which the LIM can be switched lowers as the LIMs thickness increases.

LIMs find application in a variety of systems. For example, LIMs can be employed in communication systems to encode information by light intensity modulation. In these communications systems, a light intensity level is assigned to, for example, a digital value. In operation, the LIM receives a data signal having a particular digital value. The LIM then converts the data signal into a corresponding light of assigned intensity. The light, in turn, is transmitted over an optical medium (e.g., fiber optical cable) to a destination where a decoder receives and decodes the intensity of the transmitted light to produce the original data signal. LIMs can be used in illumination systems where it is important to control the intensity of light illuminating objects such as dynamic and static image display panels. LIMs find use in medical or scientific applications where it is also important to control the intensity of light over time. LIMs can also be employed as picture elements in image displays, as noted above, where it is important to generate gray levels. SLM arrays, also referred to as light-valve arrays are used in projection displays, optical interconnects, holographic storage, and other applications where light is modulated spatially and temporally in response to an array of data.

### SUMMARY OF THE INVENTION

The present invention relates to a light intensity modulator that employs a hologram. In one embodiment, the light intensity modulator includes an electrical circuit and a holographic optical element containing the hologram. The holographic optical element is electrically coupled to and receives a variable voltage generated by the electric circuit. Additionally, the holographic optical element receives an input light from a light source. The holographic optical element receives and diffracts the input light to produce first and second output lights. An intensity of the first output light varies directly with the magnitude of the voltage. An intensity of the second output light varies indirectly with the magnitude of the voltage. The first and second output lights define a non-zero angle therebetween.

The hologram operates in an active state or an inactive state. In the active state, the hologram diffracts the input light. In the inactive state, the hologram transmits the input light without diffraction. In one embodiment, the hologram, operating in the inactive state, transmits the input light as though the hologram was transparent glass.

In another embodiment, a second holographic optical element is added. The second holographic optical element includes a second hologram. The electrical circuit generates a second voltage that varies in magnitude. The second holographic optical element is coupled to the electrical circuit receives the second voltage. The second holographic optical element also receives a second input light. The second holographic optical element produces third and forth output lights in response to receiving the second input light and the second voltage. An intensity of the third output light varies directly with the magnitude of the second voltage while an intensity of the fourth output light varies indirectly with the magnitude of the second voltage. A second non-zero angle is defined between the third and fourth output lights, wherein.

In one embodiment, the hologram is formed by exposing an interference pattern inside a polymer-dispersed liquid crystal material. This material includes, in one embodiment, a polymerizable monomer, a liquid crystal, a cross-linking monomer, and a coinitiator.

### BRIEF DESCRIPTION OF THE DRAWINGS

Other objects and advantages of the invention will become apparent upon reading the following detailed description and upon reference to the accompanying drawings in which:

FIG. 1 is a cross-sectional view of an electrically switchable hologram made of an exposed polymer dispersed liquid crystal (PDLC) material made in accordance with the teachings of the description herein;

FIG. 2 is a graph of the normalized net transmittance and normalized net diffraction efficiency of a hologram made in accordance with the teachings of the description herein (without the addition of a surfactant) versus the rms voltage applied across the hologram;

FIG. 3 is a graph of both the threshold and complete switching rms voltages needed for switching a hologram made in accordance with the teachings of the description herein to minimum diffraction efficiency versus the frequency of the rms voltage;

FIG. 4 is a graph of the normalized diffraction efficiency as a function of the applied electric field for a PDLC material formed with 34% by weight liquid crystal surfactant present and a PDLC material formed with 29% by weight liquid crystal and 4% by weight surfactant;

FIG. 5 is a graph showing the switching response time data for the diffracted beam in the surfactant-containing PDLC material in FIG. 4;

FIG. 6 is a graph of the normalized net transmittance and the normalized net diffraction efficiency of a hologram;

FIG. 7 is an elevational view of typical experimental arrangement for recording reflection gratings;

FIGS. 8a and 8b are elevational views of a reflection grating, made in accordance with the teachings of the description herein, having periodic planes of polymer channels and PDLC channels disposed parallel to the front surface in the absence of a field (FIG. 8a) and with an electric field applied (FIG. 8b) wherein the liquid-crystal utilized in the formation of the grating has a positive dielectric anisotropy;

FIGS. 9a and 9b are elevational views of a reflection grating, made in accordance with the teachings of the description herein, having periodic planes of polymer channels and PDLC channels disposed parallel to the front surface of the grating in the absence of an electric field (FIG. 9a) and with an electric field applied (FIG. 9b) wherein the liquid crystal utilized in the formation of the grating has a negative dielectric anisotropy;

FIGS. 9c and 9d depict chemical formulas of various types of liquid crystal materials;

FIG. 10a is an elevational view of a reflection grating, made in accordance with the teachings of the description herein, disposed within a magnetic field generated by Helmholtz coils;

FIGS. 10b and 10c are elevational views of the reflection grating of FIG. 10a in the absence of an electric field (FIG. 10b) and with an electric field applied (FIG. 10c);

FIGS. 11a and 11b are representative side views of a slanted transmission grating (FIG. 11a) and a slanted reflection grating (FIG. 11b) showing the orientation of the grating vector G of the periodic planes of polymer channels and PDLC channels;

FIG. 12 is an elevational view of a reflection grating, made in accordance with the teachings of the description herein, when a shear stress field is applied thereto;

FIG. 13 is an elevational view of a subwavelength grating, made in accordance with the teachings of the description herein, having periodic planes of polymer channels and PDLC channels disposed perpendicular to the front surface of the grating;

FIG. 14a is an elevational view of a switchable subwavelength, made in accordance with the teachings of the description herein, wherein the subwavelength grating functions as a half wave plate whereby the polarization of the incident radiation is rotated by 90°;

FIG. 14b is an elevational view of the switchable half wave plate shown in FIG. 14a disposed between crossed polarizers whereby the incident light is transmitted;

FIGS. 14c and 14d are side views of the switchable half wave plate and crossed polarizes shown in FIG. 14b and showing the effect of the application of a voltage to the plate whereby the polarization of the light is no longer rotated and thus blocked by the second polarizer;

FIG. 15a is a side view of a switchable subwavelength grating, made in accordance with the teachings of the description herein, wherein the subwavelength grating functions as a quarter wave plate whereby plane polarized light is transmitted through the subwavelength grating, retroreflected by a mirror and reflected by the beam splitter;

FIG. 15b is a side view of the switchable subwavelength grating of FIG. 15a and showing the effect of the application of a voltage to the plate whereby the polarization of the light is no longer modified, thereby permitting the reflected light to pass through the beam splitter;

FIGS. 16a and 16b are elevational views of a transmission grating, made in accordance with the teachings of the description herein, having periodic planes of polymer channels and PDLC channels disposed perpendicular to the front face of the grating in the absence of an electric field (FIG. 16a) and with an electric field applied (FIG. 16b) wherein the liquid crystal utilized in formation of the grating has a positive dielectric anisotropy;

FIG. 17 is a side view of five subwavelength gratings wherein the gratings are stacked and connected electrically in parallel thereby reducing the switching voltage of the subwavelength grating;

FIG. 18 is a block diagram of a LIM system employing the present invention;

FIG. 19a illustrates operational aspects of one type of switchable holographic optical element employable in the system shown in FIG. 18;

FIG. 19b illustrates operational aspects of another type of switchable holographic optical element employable in the system shown in FIG. 18;

FIG. 20a-c illustrates operational aspects of the switchable holographic optical element illustrated in FIG. 19a;

FIG. 21 is a cross sectional view of one embodiment of a monochromatic switchable holographic optical element employable in the system of FIG. 18;

FIG. 22 is a cross sectional view of one embodiment of a polychromatic switchable holographic optical element employable in system of FIG. 18;

FIG. 23 is a cross sectional view of another embodiment of a polychromatic switchable holographic optical element employable in the system of FIG. 18;

FIG. 24a is a cross sectional view of one embodiment of a monochromatic switchable holographic optical element employable as a diffractive display in the system of FIG. 18;

FIG. 24b is an elevational view of the monochromatic switchable holographic optical element shown in FIG. 24b;

FIG. 25 is a cross sectional view of one embodiment of a polychromatic switchable holographic optical element employable as a diffractive display in the system of FIG. 18;

FIG. 26 is a cross sectional view of another embodiment of a polychromatic switchable holographic optical element employable as a diffractive display in the system of FIG. 18;

FIG. 27 is a plan view of a portion or pixel of a polychromatic switchable holographic optical element employable as a diffractive display in the system of FIG. 18;

FIG. 28a is a plan view of an electrode which may be used to modulate the refractive index of polychromatic switchable holographic optical element pixel of FIG. 27;

FIG. 28b is a plan view of an electrode having sub-electrodes that may be used to modulate sub-areas of the refractive index of polychromatic switchable holographic optical element pixel of FIG. 27.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

1. Switchable Hologram Materials And Devices

The present invention employs holographic optical elements formed, in one embodiment, from a polymer dispersed liquid crystal (PDLC) material including a monomer, a dispersed liquid crystal, a cross-linking monomer, a coinitiator and a photoinitiator dye. These PDLC materials exhibit clear and orderly separation of the liquid crystal and cured polymer, whereby the PDLC material advantageously provides high quality optical elements. The PDLC materials used in the holographic optical elements may be formed in a single step. The holographic optical elements may also use a unique photopolymerizable prepolymer material that permits in situ control over characteristics of resulting gratings, such as domain size, shape, density, ordering and the like. Furthermore, methods and materials taught herein may be used to prepare PDLC materials for optical elements including switchable transmission or reflection type holographic gratings.

Polymer dispersed liquid crystal materials, methods, and devices contemplated for use in the present invention are also described in R. L. Sutherland et al., “Bragg Gratings in an Acrylate Polymer Consisting of Periodic Polymer dispersed Liquid-Crystal Planes,” Chemistry of Materials, No. 5, pp. 1533-1538 (1993); in R. L. Sutherland et al., “Electrically switchable volume gratings in polymer dispersed liquid crystals,” Applied Physics Letters, Vol. 64, No. 9, pp. 1074-1076 (1994); and T. J. Bunning et al., “The Morphology and Performance of Holographic Transmission Gratings Recorded in Polymer dispersed Liquid Crystals,” Polymer, Vol. 36, No. 14, pp. 2699-2708 (1995), all of which are fully incorporated by reference into this Detailed Description. U.S. patent application Ser. Nos. 08/273, 436 and U.S. Pat. No. 5,698,343 to Sutherland et al., titled “Switchable Volume Hologram Materials and Devices,” and “Laser Wavelength Detection and Energy Dosimetry Badge,” respectively, are also incorporated by reference and include background material on the formation of transmission gratings inside volume holograms.

The process by which a hologram may be formed is controlled primarily by the choice of components used to prepare the homogeneous starting mixture, and to a lesser extent by the intensity of the incident light pattern. In one embodiment of polymer dispersed liquid crystal (PDLC) material may be used to create a switchable hologram in a single step. A feature of one embodiment of PDLC material is that illumination by an inhomogeneous, coherent light pattern initiates a patterned, anisotropic diffusion (or counter diffusion) of polymerizable monomer and second phase material, particularly liquid crystal (LC). Thus, alternating well-defined channels of second phase-rich material, separated by well-defined channels of a nearly pure polymer, may be produced in a single-stop process.

The resulting PDLC material may have an anisotropic spatial distribution of phase-separated LC droplets within the photochemically cured polymer matrix. Prior art PDLC materials made by a single-step process may achieve at best only regions of larger LC bubbles and smaller LC bubbles in a polymer matrix. The large bubble sizes are highly scattering which produces a hazy appearance and multiple ordering diffractions, in contrast to the well-defined first order diffraction and zero order diffraction made possible by the small LC bubbles of one embodiment of PDLC material in well-defined channels of LC-rich material. Reasonably well-defined alternately LC-rich channels and nearly pure polymer channels in a PDLC material are possible by multi-step processes, but such processes do not achieve the precise morphology control over LC droplet size and distribution of sizes and widths of the polymer and LC-rich channels made possible by one embodiment of PDLC material.

The same may be prepared by coating the mixture between two indium-tin-oxide (ITO) coated glass slides separated by spacers of nominally 10-20 μm thickness. The sample is placed in a conventional holographic recording setup. Gratings are typically recorded using the 488 nm line of an Argon ion laser with intensities of between about 0.1-100 mW/cm² and typical exposure times of 30-120 seconds. The angle between the two beams is varied to vary the spacing of the intensity peaks, and hence the resulting grating spacing of the hologram. Photopolymerization is induced by the optical intensity pattern. A more detailed discussion of exemplary recording apparatus may be found in R. L. Sutherland, et al., “Switchable holograms in new photopolymer-liquid crystal composite materials,” Society of Photo-Optical Instrumentation Engineers (SPIE), Proceedings Reprint, Volume 2402, reprinted from Diffractive and Holographic Optics Technology II (1995), incorporated herein by reference.

The features of the PDLC material are influenced by the components used in the preparation of the homogeneous starting mixture and, to a lesser extent, by the intensity of the incident light pattern. In one embodiment, the prepolymer material comprises a mixture of a photopolymerizable monomer, a second phase material, a photoinitiator dye, a coinitiator, a chain extender (or cross-linker), and, optionally, a surfactant.

In one embodiment, two major components of the prepolymer mixture are the polymerizable monomer and the second phase material, which are preferably completely miscible. Highly functionalized monomers may be preferred because they form densely cross-linked networks which shrink to some extent and to tend to squeeze out the second phase material. As a result, the second phase material is moved anisotropically out of the polymer region and, thereby, separated into well-defined polymer-poor, second phase-rich regions or domains. Highly functionalized monomers may also be preferred because the extensive cross-linking associated with such monomers yields fast kinetics, allowing the hologram to form relatively quickly, whereby the second phase material will exist in domains of less than approximately 0.1 μm.

In one embodiment, a mixture of penta-acrylates in combination with di-, tri-, and/or tetra-acrylates may be used in order to optimize both the functionality and viscosity of the prepolymer material. Suitable acrylates, such as triethyleneglycol diacrylate, trimethylolpropane triacrylate, pentaerythritol triacrylate, pentaerythritol tetracrylate, pentaerythritol pentacrylate, and the like may be used. In one embodiment, it has been found that an approximately 1:4 mixture of tri- to penta-acrylate facilitates homogeneous mixing while providing a favorable mixture for forming 10-20 μm films on the optical plates.

The second phase material of choice is a liquid crystal (LC). This also allows an electro-optical response for the resulting hologram. The concentration of LC employed should be large enough to allow a significant phase separation to occur in the cured sample, but not so large as to make the sample opaque or very hazy. Below about 20% by weight very little phase separation occurs and diffraction efficiencies are low. Above about 35% by weight, the sample becomes highly scattering, reducing both diffraction efficiency and transmission. Samples fabricated with approximately 25% by weight typically yield good diffraction efficiency and optical clarity. In prepolymer mixtures utilizing a surfactant, the concentration of LC may be increased to 35% by weight without loss in optical performance by adjusting the quantity of surfactant. Suitable liquid crystals contemplated for use in the practice of the present invention may include the mixture of cyanobiphenyls marketed as E7 by Merck, 4′-n-pentyl-4-cyanobiphenyl, 4′-n-heptyl-4-cyanobiphenyl, 4′-octaoxy-4-cyanobiphenyl, 4′-pentyl-4-cyanoterphenyl, ∝-methoxybenzylidene-4′-butylaniline, and the like. Other second phase components are also possible.

The polymer dispersed liquid crystal material employed may be formed from a prepolymer material that is a homogeneous mixture of a polymerizable monomer including dipentaerythritol hydroxypentacrylate (available, for example, from Polysciences, Inc., Warrington, Pa.), approximately 10-40 wt % of the liquid crystal E7 (which is a mixture of cyanobiphenyls marketed as E7 by Merck and also available from BDH Chemicals, Ltd., London, England), the chain-extending monomer N-vinylpyrrolidinone (“NVP”) (available from the Aldrich Chemical Company, Milwaukee, Wis.), coinitiator N-phenylglycine (“NPG”) (also available from the Aldrich Chemical Company, Milwaukee, Wis.), and the photoinitiator dye rose bengal ester; (2,4,5,7-tetraiodo-3′,4′,5′,6′-tetrachlorofluorescein-6-acetate ester) marketed as RBAX by Spectragraph, Ltd., Maumee, Ohio). Rose bengal is also available as rose bengal sodium salt (which must be esterified for solubility) from the Aldrich Chemical Company. This system has a very fast curing speed which results in the formation of small liquid crystal micro-droplets.

The mixture of liquid crystal and prepolymer material are homogenized to a viscous solution by suitable means (e.g., ultrasonification) and spread between indium-tin-oxide (ITO) coated glass sides with spacers of nominally 15-100 μm thickness and, preferably, 10-20 μm thickness. The ITO is electrically conductive and serves as an optically transparent electrode. Preparation, mixing and transfer of the prepolymer material onto the glass slides are preferably done in the dark as the mixture is extremely sensitive to light.

The sensitivity of the prepolymer materials to light intensity is dependent on the photoinitiator dye and its concentration. A higher dye concentration leads to a higher sensitivity. In most cases, however, the solubility of the photoinitiator dye limits the concentration of the dye and, thus, the sensitivity of the prepolymer material. Nevertheless, it has been found that for more general applications, photoinitiator dye concentrations in the range of 0.2-0.4% by weight are sufficient to achieve desirable sensitivities and allow for a complete bleaching of the dye in the recording process, resulting in colorless final samples. Photoinitiator dyes that may be useful in generating PDLC materials are rose bengal ester (2,4,5,7-tetraiodo-3′,4′,5′,6′-tetrachlorofluorescein-6-acetate ester); rose bengal sodium salt; eosin; eosin sodium salt; 4,5-diiodosuccinyl fluorescein; camphorquinone; methylene blue, and the like. These dyes allow a sensitivity to recording wavelengths across the visible spectrum from nominally 400 nm to 700 nm. Suitable near-infrared dyes, such as cationic cyanine dyes with trialkylborate anions having absorption from 600-900 nm as well as merocyanine dyes derived from spiropyran may also find utility in the present invention.

The coinitiator employed in the practice of the present invention controls the rate of curing in the free radical polymerization reaction of the prepolymer material. Optimum phase separation and, thus, optimum diffraction efficiency in the resulting PDLC material, are a function of curing rate. It has been found that favorable results may be achieved utilizing coinitiator in the range of 2-3% by weight. Suitable coinitiators include N-phenylglycine; triethyl amine; triethanolamine; N,N-dimethyl-2,6-diisopropyl aniline, and the like.

Other suitable dyes and dye coinitiator combinations that may be suitable for use in the present invention, particularly for visible light, include eosin and triethanolamine; camphorquinone and N-phenylglycine; fluorescein and triethanolamine; methylene blue and triethanolamine or N-phenylglycine; erythrosin B and triethanolamine; indolinocarbocyanine and triphenyl borate; iodobenzospiropyran and triethylamine, and the like.

The chain extender (or cross linker) employed in the practice of the present invention may help to increase the solubility of the components in the prepolymer material as well as increase the speed of polymerization. The chain extender is preferably a smaller vinyl monomer as compared with the pentacrylate, whereby it may react with the acrylate positions in the pentacrylate monomer, which are not easily accessible to neighboring pentaacrylate monomers due to steric hindrance. Thus, reaction of the chain extender monomer with the polymer increases the propagation length of the growing polymer and results in high molecular weights. It has been found that chain extender in general applications in the range of 10-18% by weight maximizes the performance in terms of diffraction efficiency. In the one embodiment, it is expected that suitable chain extenders may be selected from the following: N-vinylpyrrolidinone; N-vinyl pyridine; acrylonitrile; N-vinyl carbazole, and the like.

It has been found that the addition of a surfactant material, namely, octanoic acid, in the prepolymer material lowers the switching voltage and also improves the diffraction efficiency. In particular, the switching voltage for PDLC materials containing a surfactant are significantly lower than those of a PDLC material made without the surfactant. While not wishing to be bound by any particular theory, it is believed that these results may be attributed to the weakening of the anchoring forces between the polymer and the phase-separated LC droplets. SEM studies have shown that droplet sizes in PDLC materials including surfactants are reduced to the range of 30-50 nm and the distribution is more homogeneous. Random scattering in such materials is reduced due to the dominance of smaller droplets, thereby increasing the diffraction efficiency. Thus, it is believed that the shape of the droplets becomes more spherical in the presence of surfactant, thereby contributing to the decrease in switching voltage.

For more general applications, it has been found that samples with as low as 5% by weight of surfactant exhibit a significant reduction in switching voltage. It has also been found that, when optimizing for low switching voltages, the concentration of surfactant may vary up to about 10% by weight (mostly dependent on LC concentration) after which there is a large decrease in diffraction efficiency, as well as an increase in switching voltage (possibly due to a reduction in total phase separation of LC). Suitable surfactants include octanoic acid; heptanoic acid; hexanoic acid; dodecanoic acid; decanoic acid, and the like.

In samples utilizing octanoic acid as the surfactant, it has been observed that the conductivity of the sample is high, presumably owing to the presence of the free carboxyl (COOH) group in the octanoic acid. As a result, the sample increases in temperature when a high frequency (˜2 KHz) electrical field is applied for prolonged periods of time. Thus, it is desirable to reduce the high conductivity introduced by the surfactant, without sacrificing the high diffraction efficiency and the low switching voltages. It has been found that suitable electrically switchable gratings may be formed from a polymerizable monomer, vinyl neononanoate (“VN”) C₈H₁₇CO₂CH═CH₂, commercially available from the Aldrich Chemical Co. in Milwaukee, Wis. Favorable results have also been obtained where the chain extender N-vinylpyrrolidinone (“NVP”) and the surfactant octanoic acid are replaced by 6.5% by weight VN. VN also acts as a chain extender due to the presence of the reactive acrylate monomer group. In these variations, high optical quality samples were obtained with about 70% diffraction efficiency, and the resulting gratings could be electrically switched by an applied field of 6 V/μm.

PDLC materials used in the present invention may also be formed using a liquid crystalline bifunctional acrylate as the monomer (“LC monomer”). LC monomers have an advantage over conventional acrylate monomers due to their high compatibility with the low molecular weight nematic LC materials, thereby facilitating formation of high concentrations of low molecular weight LC and yielding a sample with high optical quality. The presence of higher concentrations of low molecular weight LCs in the PDLC material greatly lowers the switching voltages (e.g., to ˜2 V/μm). Another advantage of using LC monomers is that it is possible to apply low AC or DC fields while recording holograms to pre-align the host LC monomers and low molecular weight LC so that a desired orientation and configuration of the nematic directors may be obtained in the LC droplets. The chemical formulate of several suitable LC monomers are as follows:

CH₂═CH—COO—(CH₂)₆O—C₆H₅—C₆H₅—COO—CH═CH₂

CH₂═CH—(CH₂)₈—COO—C₆H₅—COO—(CH₂)₈—CH═CH₂

H(CF₂)₁₀CH₂O—CH₂—C(═CH₂)—COO—(CH₂CH₂O)₃CH₂CH₂O—COO—CH₂C(═CH₂)—CH₂O(CF₂)₁₀H

Semifluorinated polymers are known to show weaker anchoring properties and also significantly reduced switching fields. Thus, it is believed that semifluorinated acrylate monomers which are bifunctional and liquid crystalline may find suitable application in the present invention.

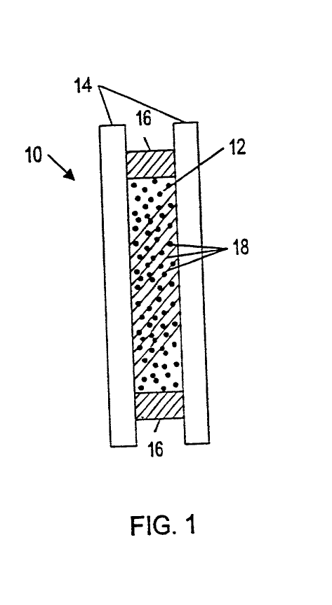

Referring now to FIG. 1, there is shown a cross-sectional view of an electrically switchable hologram 10 made of an exposed polymer dispersed liquid crystal material made according to the teachings of this description. A layer 12 of the polymer dispersed liquid crystal material is sandwiched between a pair of indium-tin-oxide coated glass slides 14 and spacers 16. The interior of hologram 10 shows Bragg transmission gratings 18 formed when layer 12 was exposed to an interference pattern from two intersecting beams of coherent laser light. The exposure times and intensities may be varied depending on the diffraction efficiency and liquid crystal domain size desired. Liquid crystal domain size may be controlled by varying the concentrations of photoinitiator, coinitiator and chain-extending (or cross-linking) agent. The orientation of the nematic directors may be controlled while the gratings are being recorded by application of an external electric field across the ITO electrodes.

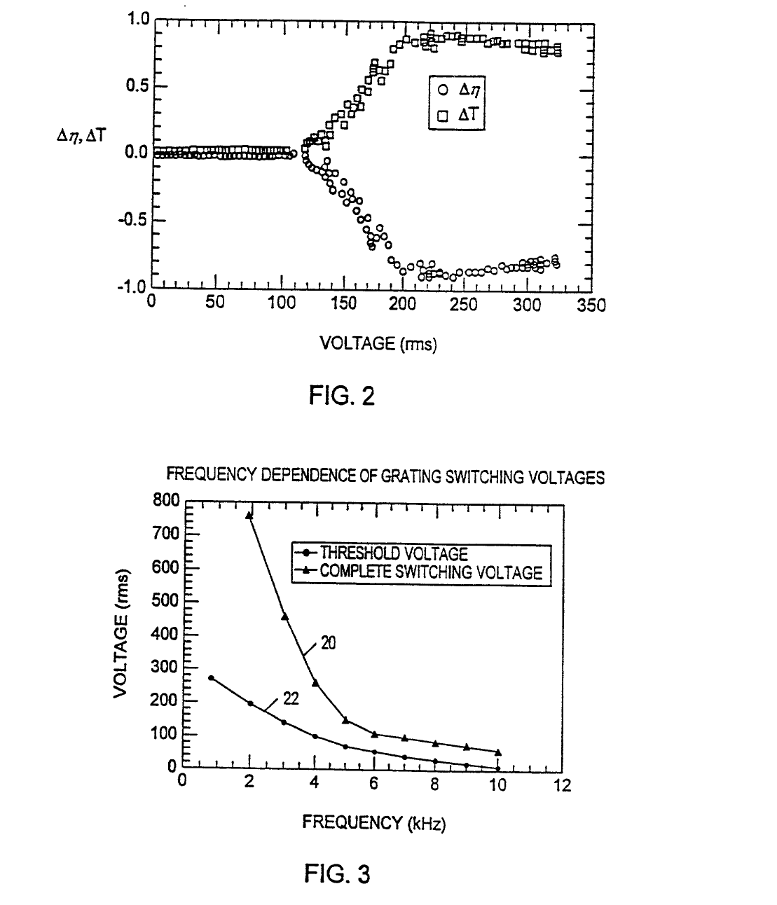

The scanning electron micrograph shown in FIG. 2 of the referenced Applied Physics Letters article and incorporated herein by reference is of the surface of a grating which was recorded in a sample with a 36 wt % loading of liquid crystal using the 488 nm line of an argon ion laser at an intensity of 95 mW/cm². The size of the liquid crystal domains is about 0.2 μm and the grating spacing is about 0.54 μm. This sample, which is approximately 20 μm thick, diffracts light in the Bragg regime.

FIG. 2 is a graph of the normalized net transmittance and normalized net diffraction efficiency of a hologram made according to the teachings of his disclosure versus the root mean square voltage (“Vrms”) applied across the hologram. Δη is the change in first order Bragg diffraction efficiency. ΔT is the change in zero order transmittance. FIG. 2 shows that energy is transferred from the first order beam to the zero-order beam as the voltage is increased. There is a true minimum of the diffraction efficiency at approximately 225 Vrms. The peak diffraction efficiency may approach 100%, depending on the wavelength and polarization of the probe beam, by appropriate adjustment of the sample thickness. The minimum diffraction efficiency may be made to approach 0% by slight adjustment of the parameters of the PDLC material to force the refractive index of the cured polymer to be equal to the ordinary refractive index of the liquid crystal.

By increasing the frequency of the applied voltage, the switching voltage for minimum diffraction efficiency may be decreased significantly. This is illustrated in FIG. 3, which is a graph of both the threshold rms voltage 20 and the complete switching rms voltage 22 needed for switching a hologram made according to the teachings of this disclosure to minimum diffraction efficiency versus the frequency of the rms voltage. The threshold and complete switching rms voltages are reduced to 20 Vrms and 60 Vrms, respectively, at 10 kHz. Lower values are expected at even higher frequencies.

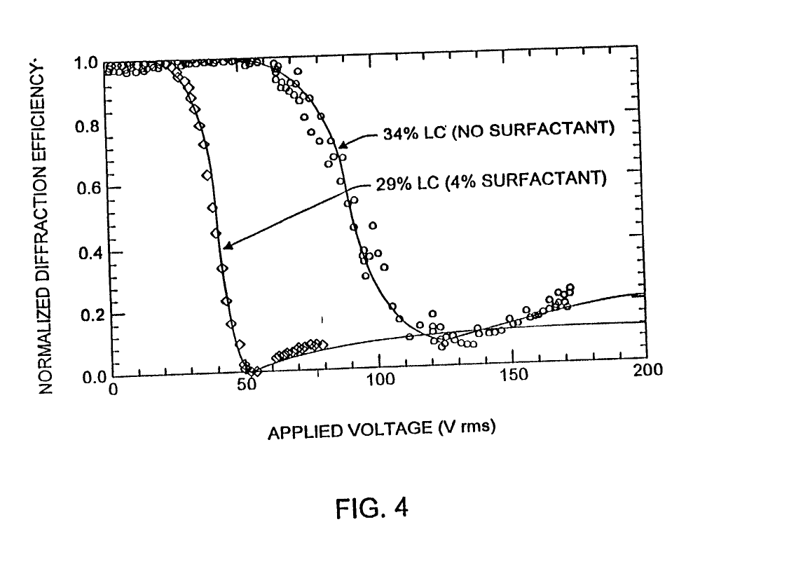

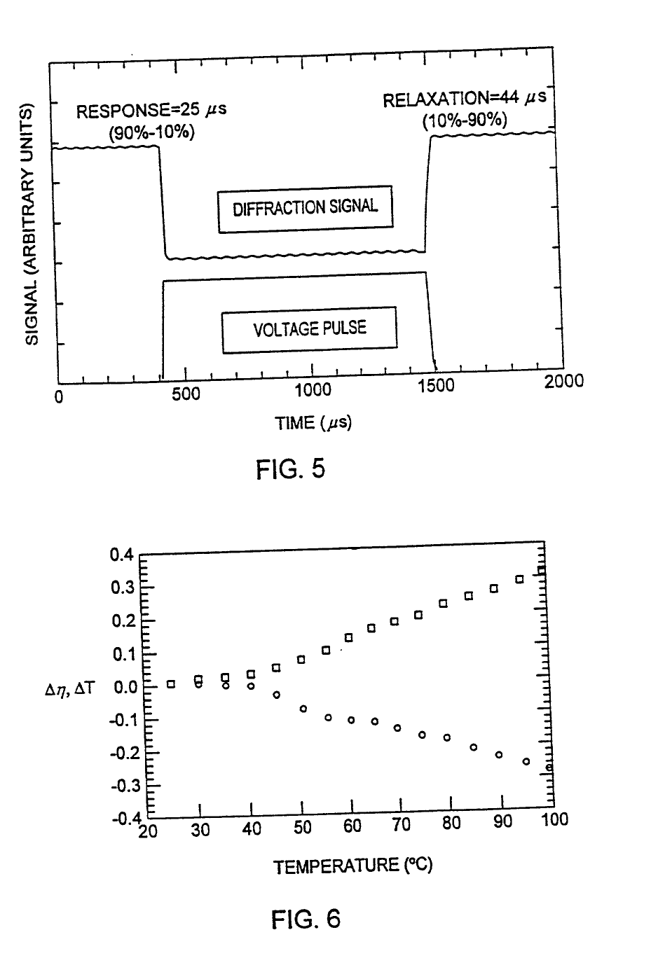

Smaller liquid crystal droplet sizes have the problem that it takes high switching voltages to switch their orientation. As described in the previous paragraph, using alternating current switching voltages at high frequencies helps reduce the needed switching voltage. As demonstrated in FIG. 4, it has been found that adding a surfactant (e.g., octanoic acid) the prepolymer material in amounts of about 4%-6% by weight of the total mixture results in sample holograms with switching voltages near 50 Vrms at lower frequencies of 1-2 kHz. As shown in FIG. 5, it has also been found that the use of the surfactant with the associated reduction in droplet size, reduces the switching time of the PDLC materials. Thus, samples made with surfactant may be switched on the order of 25-44 microseconds. Without wishing to be bound by any theory, the surfactant is believed to reduce switching voltages by reducing the anchoring of the liquid crystals at the interface between liquid crystal and cured polymer.

Thermal control of diffraction efficiency is illustrated in FIG. 5. FIG. 5 is a graph of the normalized net transmittance and normalized net diffraction efficiency of a hologram made according to the teachings of this disclosure versus temperature.

The polymer dispersed liquid crystal materials described herein successfully demonstrate the utility for recording volume holograms of a particular composition for such polymer dispersed liquid crystal systems.

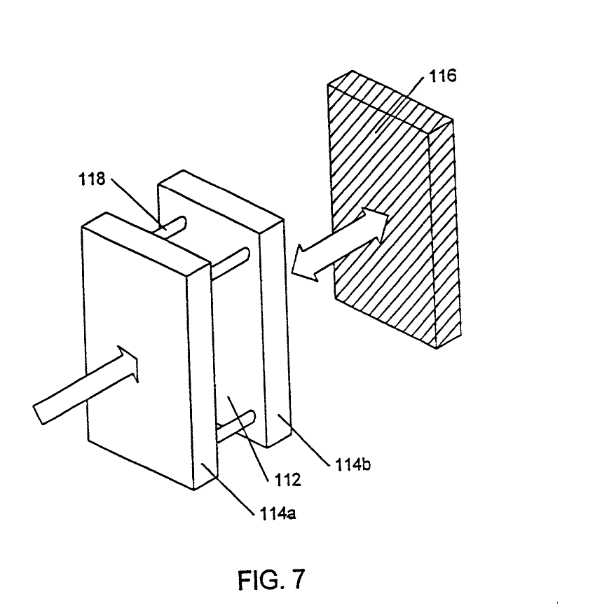

As shown in FIG. 7, a PDLC reflection grating is prepared by placing several drops of the mixture of prepolymer material 112 on an indium-tin oxide coated glass slide 114a. A second indium-tin oxide coated slide 114b is then pressed against the first, thereby causing the prepolymer material 112 to fill the region between the slides 114a and 114b. Preferably, the separation of the slides is maintained at approximately 20 μm by utilizing uniform spacers 118. Preparation, mixing and transfer of the prepolymer material is preferably done in the dark. Once assembled, a mirror 116 may be placed directly behind the glass plate 114b. The distance of the mirror from the sample is preferably substantially shorter than the coherence length of the laser. The PDLC material is preferably exposed to the 488 nm line of an argon-ion laser, expanded to fill the entire plane of the glass plate, with an intensity of approximately 0.1-100 mWatts/cm² with typical exposure times of 30-120 seconds. Constructive and destructive interference within the expanded beam establishes a periodic intensity profile through the thickness of the film.

In one embodiment, the prepolymer material utilized to make a reflection grating comprises a monomer, a liquid crystal, a cross-linking monomer, a coinitiator, and a photoinitiator dye. The reflection grating may be formed from prepolymer material including by total weight of the monomer dipentaerythritol hydroxypentacrylate (DPHA), 35% by total weight of a liquid crystal including a mixture of cyano biphenyls (known commercially as “E7”), 10% by total weight of a cross-linking monomer including N-vinylpyrrolidinone (“NVP”), 2.5% by weight of the coinitiator N-phenylglycine (“NPG”),and 10⁻⁵ to 10⁻⁶ gram moles of a photoinitiator dye including rose bengal ester. Further, as with transmission gratings, the addition of surfactants is expected to facilitate the same advantageous properties discussed above in connection with transmission gratings. It is also expected that similar ranges and variation of prepolymer starting material will find ready application in the formation of suitable reflection gratings.

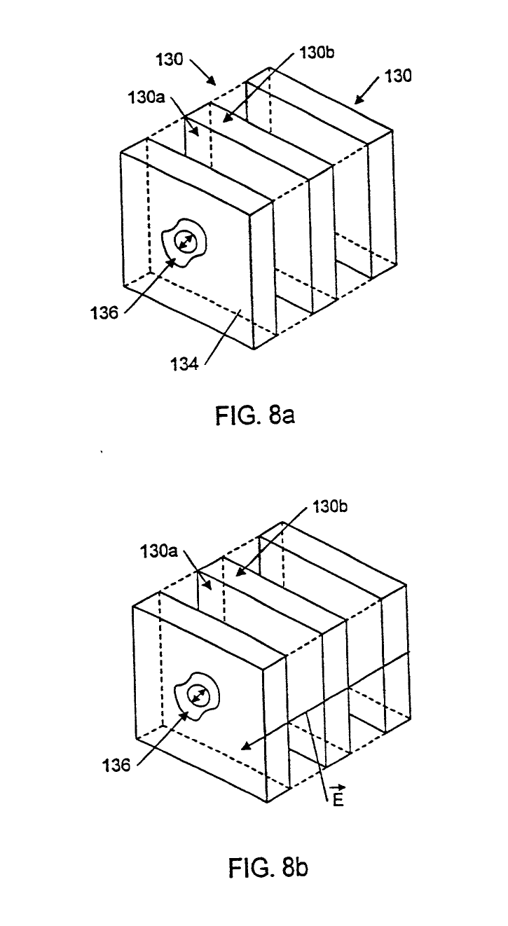

It has been determined by low voltage, high resolution scanning electron microscopy (“LVHRSEM”) that the resulting material comprises a fine grating with a periodicity of 165 nm with the grating vector perpendicular to the plane of the surface. Thus, as shown schematically in FIG. 8a, grating 130 includes periodic planes of polymer channels 1 30a and PDLC channels 130b which run parallel to the front surface 134. The grating spacing associated with these periodic planes remains relatively constant throughout the full thickness of the sample from the air/film to the film/substrate interface.

Although interference is used to prepare both transmission and reflection gratings, the morphology of the reflection grating differs significantly. In particular, it has been determined that, unlike transmission gratings with similar liquid crystal concentrations, very little coalescence of individual droplets was evident. Further more, the droplets that were present in the material were significantly smaller having diameters between 50 and 100 nm. Furthermore, unlike transmission gratings where the liquid crystal-rich regions typically comprise less than 40% of the grating, the liquid crystal-rich component of a reflection grating is significantly larger. Due to the much smaller periodicity associated with reflection gratings, i.e., a narrower grating spacing (˜0.2 microns), it is believed that the time difference between completion of curing in high intensity versus low intensity regions is much smaller. It is also believed that the fast polymerization, as evidenced by small droplet diameters, traps a significant percentage of the liquid crystal in the matrix during gelation and precludes any substantial growth of large droplets or diffusion of small droplets into larger domains.

Analysis of the reflection notch in the absorbance spectrum supports the conclusion that a periodic refractive index modulation is disposed through the thickness of the film. In PDLC materials that are formed with the 488 nm line of an argon ion laser, the reflection notch typically has a reflection wavelength at approximately 472 nm for normal incidence and a relatively narrow bandwidth. The small difference between the writing wavelength and the reflection wavelength (approximately 5%) indicates that shrinkage of the film is not a significant problem. Moreover, it has been found that the performance of such gratings is stable over periods of many months.

In addition to the materials utilized in the one embodiment described above, it is believed that suitable PDLC materials could be prepared utilizing monomers such as triethyleneglycol diacrylate, trimethylolpropanetriacrylate, pentaerythritol triacrylate, pentaerythritol tetracrylate, pentaerythritol pentacrylate, and the like. Similarly, other coinitiators such as triethylamine, triethanolamine, N,N-dimethyl-2,6-diisopropylaniline, and the like could be used instead of N-phenylglycine. Where it is desirable to use the 458 nm, 476 nm, 488 nm or 514 nm lines of an Argon ion laser, the photoinitiator dyes rose bengal sodium salt, eosin, eosin sodium salt, fluorescein sodium salt and the like will give favorable results. Where the 633 nm line is utilized, methylene blue will find ready application. Finally, it is believed that other liquid crystals such as 4′-pentyl-4-cyanobiphenyl or 4′-heptyl-4-cyanobiphenyl, may be utilized.

Referring again to FIG. 8a, there is shown an elevational view of a reflection grating 130 made in accordance with this disclosure having periodic planes of polymer channels 130a and PDLC channels 130b disposed parallel to the front surface 134 of the grating 130. The symmetry axis 136 of the liquid crystal domains is formed in a direction perpendicular to the periodic channels 130a and 130b of the grating 130 and perpendicular to the front surface 134 of the grating 130. Thus, when an electric field E is applied, as shown in FIG. 8b, the symmetry axis 136 is already in a low energy state in alignment with the field E and will reorient. Thus, reflection gratings formed in accordance with the procedure described above will not normally be switchable.

In general, a reflection grating tends to reflect a narrow wavelength band, such that the grating may be used as a reflection filter. In one embodiment, however, the reflection grating is formed so that it will be switchable. More particularly, switchable reflection gratings may be made utilizing negative dielectric anisotropy LCs (or LCs with a low cross-over frequency), an applied magnetic field, an applied shear stress field, or slanted gratings.

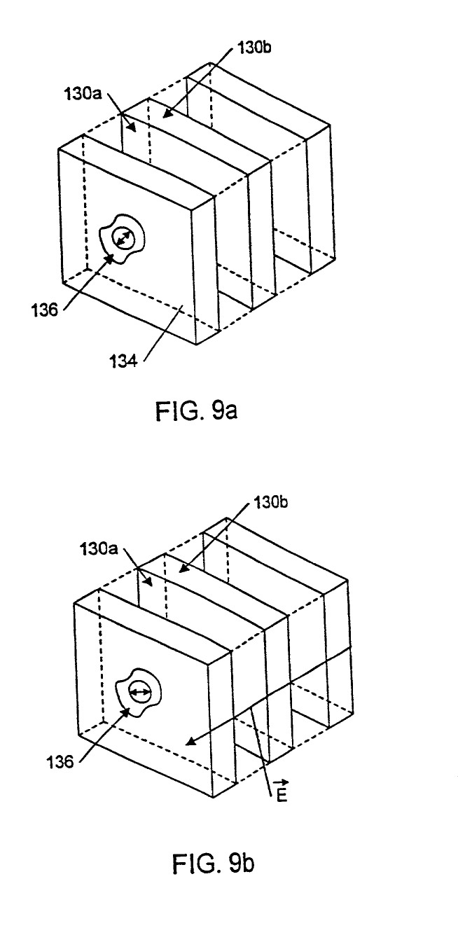

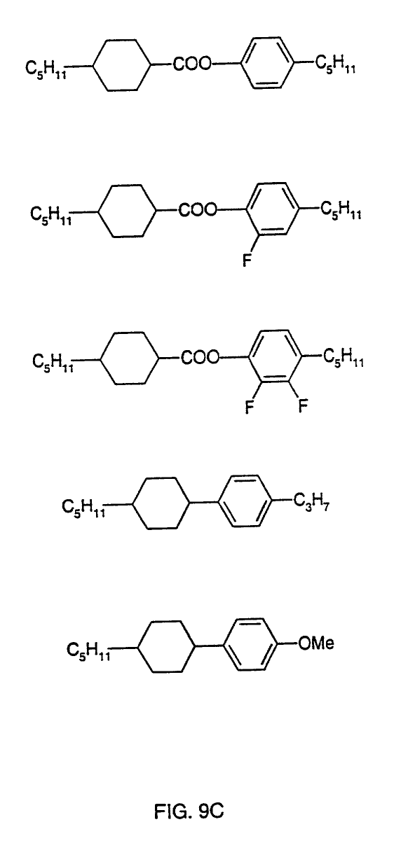

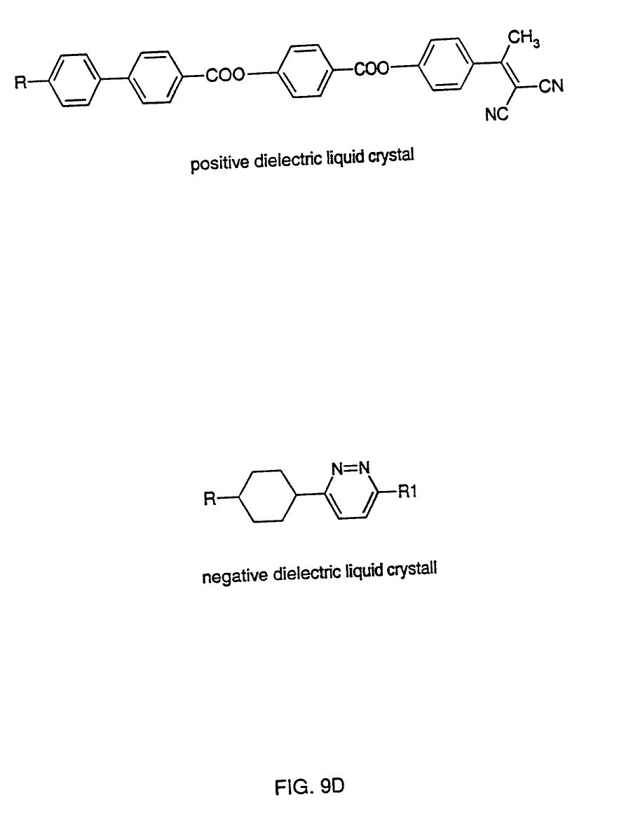

It is known that liquid crystals having a negative dielectric anisotropy (Δ≮) will rotate in a direction perpendicular to an applied field. As shown in FIG. 9a, the symmetry axis 136 of the liquid crystal domains formed with a liquid crystal having a negative Δ≮ will also be disposed in a direction perpendicular to the periodic channels 130a and 130b of the grating 130 and to the front surface 135 of the grating. However, when an electric field E is applied across such gratings, as shown in FIG. 9b, the symmetry axis of the negative Δ≮ liquid crystal will distort and reorient in a direction perpendicular to the field E, which is perpendicular to the film and the periodic planes of the grating. As a result, the reflection grating may be switched between a state where it is reflective and a state where it is transmissive. FIG. 9c depicts some examples of negative Δ≮ liquid crystals which may be in the methods and devices described herein.

Liquid crystals may be found in nature (or synthesized) with either positive or negative Δ≮. Thus, it is possible to use a LC which has a positive Δ≮ at low frequencies, but becomes negative at high frequencies. The frequency (of the applied voltage) at which Δ≮ changes sign is called the cross-over frequency. The cross-over frequency will vary with LC composition, and typical values range from 1-10 kHz. Thus, by operating at the proper frequency, the reflection grating may be switched. It is expected that low crossover frequency materials may be prepared from a combination of positive and negative dielectric anisotropy liquid crystals. A suitable positive dielectric liquid crystal for use in such a combination contains four ring esters as shown in FIG. 9D. A strongly negative dielectric liquid crystal suitable for use in such a combination is made up of pyridazines as shown in FIG. 9D. Both liquid crystal materials are available from LaRoche & Co., Switzerland. By varying the proportion of the positive and negative liquid crystals in the combination, crossover frequencies form 1.4-2.3 kHz are obtained at room temperature. Another combination suitable for use in the present embodiment is a combination of the following: p-pentylphenyl-2-chloro-4-(p-pentylbenzoyloxy) benzoate and benzoate. These materials are available from Kodak Company.

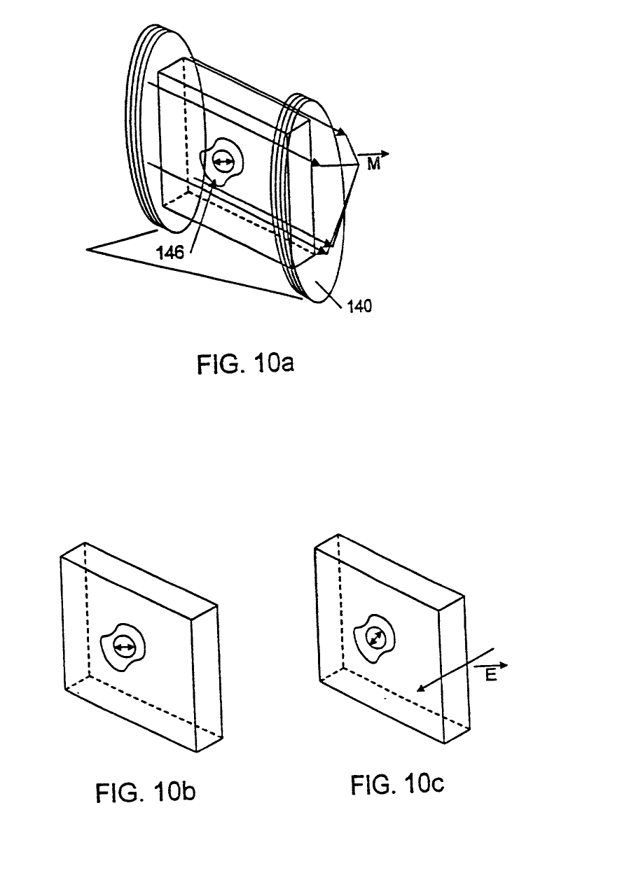

In still more detailed aspects, switchable reflection gratings may be formed using positive Δ≮ liquid crystals. As shown in FIG. 10a, such gratings are formed by exposing the PDLC starting material to a magnetic field during the curing process. The magnetic field may be generated by the use of Helmholtz coils (as shown in FIG. 10a), the use of a permanent magnet, or other suitable means. Preferably, the magnetic field M is oriented parallel to the front surface of the glass plates (not shown) that are used to form the grating 140. As a result, the symmetry axis 146 of the liquid crystals will orient along the field while the mixture is fluid. When polymerization is complete, the field may be removed and the alignment of the symmetry axis of the liquid crystals will remain unchanged. (See FIG. 10b.) When an electric field is applied, as shown in FIG. 10c the positive Δ≮ liquid crystal will reorient in the direction of the field, which is perpendicular to the front surface of grating and to the periodic channels of the grating.

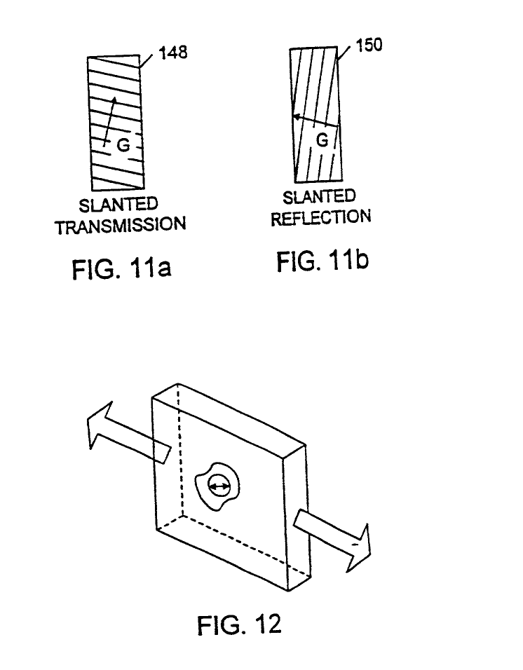

FIG. 11a depicts a slanted transmission grating 148 and FIG. 11b depicts a slanted reflection grating 150. A holographic transmission grating is considered slanted if the direction of the grating vector G is not parallel to the grating surface. In a holographic reflection grating, the grating is said to be slanted if the grating vector G is not perpendicular to the grating surface. Slanted gratings have many of the same uses as nonslanted grating such as visual displays, mirrors, line filters, optical switches, and the like.

Primarily, slanted holographic gratings are used to control the direction of a diffracted beam. For example, in reflection holograms a slanted grating is used to separate the specular reflection of the film from the diffracted beam. In a PDLC holographic grating, a slanted grating has an even more useful advantage. The slant allows the modulation depth of the grating to be controlled by an electric field when using either tangential or homeotropic aligned liquid crystals. This is because the slant provides components of the electric field in the directions both tangent and perpendicular to the grating vector. In particular, for the reflection grating, the LC domain symmetry axis will be oriented along the grating vector G and may be switched to a direction perpendicular to the film plane by a longitudinally applied field E. This is the typical geometry for switching of the diffraction efficiency of the slanted reflection grating.

When recording slanted reflection gratings, it is desirable to place the sample between the hypotenuses of two right-angle glass prisms. Neutral density filters may then be placed in optical contact with the back faces of the prisms using index matching fluids so as to frustrate back reflections which would cause spurious gratings to also be recorded. The incident laser beam is split by a conventional beam splitter into two beams which are then directed to the front faces of the prisms, and then overlapped in the sample at the desired angle. The beams thus enter the sample from opposite sides. This prism coupling technique permits the light to enter the sample at greater angles. The slant of the resulting grating is determined by the angle which the prism assembly is rotated (i.e., the angle between the direction of one incident beam an the normal to the prism front face at which that beam enters the prism).

As shown in FIG. 12, switchable reflection gratings may be formed in the presence of an applied shear stress field. In this method, a shear stress would be applied along the direction of a magnetic field M. This could be accomplished, for example, by applying equal and opposite tensions to the two ITO coated glass plates which sandwich the prepolymer mixture while the polymer is still soft. This shear stress would distort the LC domains in the direction of the stress, and the resultant LC domain symmetry axis will be preferentially along the direction of the stress, parallel to the PDLC planes and perpendicular to the direction of the applied electric field for switching.

Reflection grating prepared in accordance with this description may find application in color reflective displays, switchable wavelength filters for laser protection, reflective optical elements and the like.

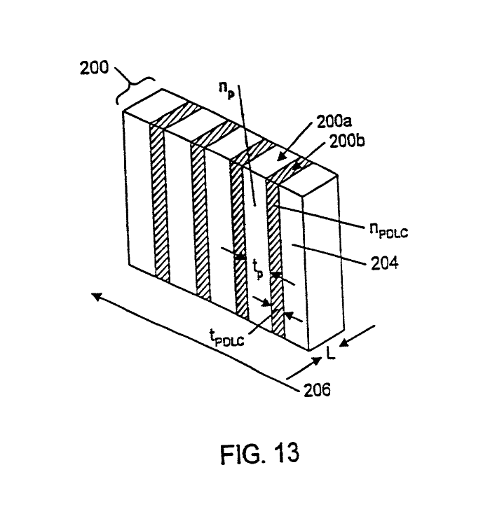

In one embodiment, PDLC materials may be made that exhibit a property known as form birefringence whereby polarized light that is transmitted through the grating will have its polarization modified. Such gratings are known as subwavelength gratings, and they behave like a negative uniaxial crystal, such as calcite, potassium dihydrogen phosphate, or lithium niobate, with an optic axis perpendicular to the PDLC planes. Referring now to FIG. 13, there is shown an elevational view of a transmission grating 200 made in accordance with this description having periodic planes of polymer planes 200a and PDLC planes 200b disposed perpendicular to the front surface 204 of the grating 200. The optic axis 206 is disposed perpendicular to polymer planes 200a and the PDLC planes 200b. Each polymer plane 200a has a thickness tₚ and refractive index nₚ, and each PDLC plane 200b has a thickness t_{PDLC} and refractive index n_{PDLC}.

Where the combined thickness of the PDLC plane and the polymer plane is substantially less than an optical wavelength (i.e. (t_{PDLC}+tₚ)<<λ), the grating will exhibit form birefringence. As discussed below, the magnitude of the shift in polarization is proportional to the length of the grating. Thus, by carefully selecting the length, L, of the subwavelength grating for a given wavelength of light, one may rotate the plane of polarization or create circularly polarized light. Consequently, such subwavelength gratings may be designed to act as a half-wave or quarter-wave plate, respectively. Thus, an advantage of this process is that the birefringence of the material may be controlled by simple design parameters and optimized to a particular wavelength, rather than relying on the given birefringence of any material at that wavelength.

To form a half-wave plate, the retardance of the subwavelength grating must be equal to one-half of a wavelength, i.e. retardance=λ/2, and to form a quarter-wave plate, the retardance must be equal to one-quarter of a wavelength, i.e. retardance=λ/4. It is known that the retardance is related to the net birefringence, |Δn|, which is the difference between the ordinary index of refraction, nₒ, and the extraordinary index of refraction nₑ, of the sub-wavelength grating by the following relation:

Retardance=|Δn|L=|nₑ-nₒ|L

Thus, for a half-wave plate, i.e. a retardation equal to one-half of a wavelength, the length of the subwavelength grating should be selected so that:

L=λ/(2|Δn|)

Similarly, for a quarter-wave plate, i.e. a retardance equal to one-quarter of a wavelength, the length of the subwavelength grating should be selected so that:

L=λ/(4|Δn)

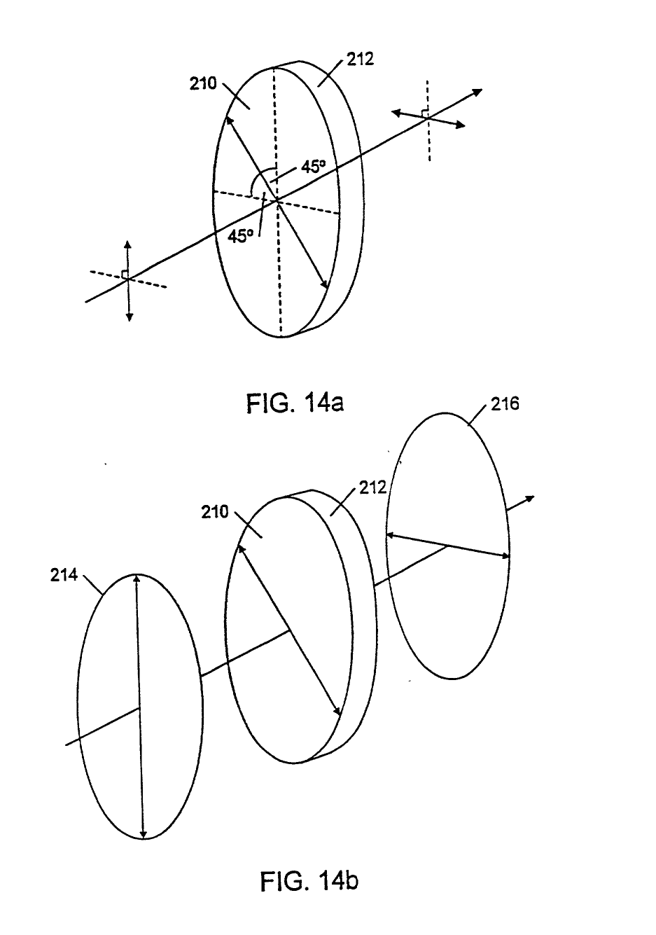

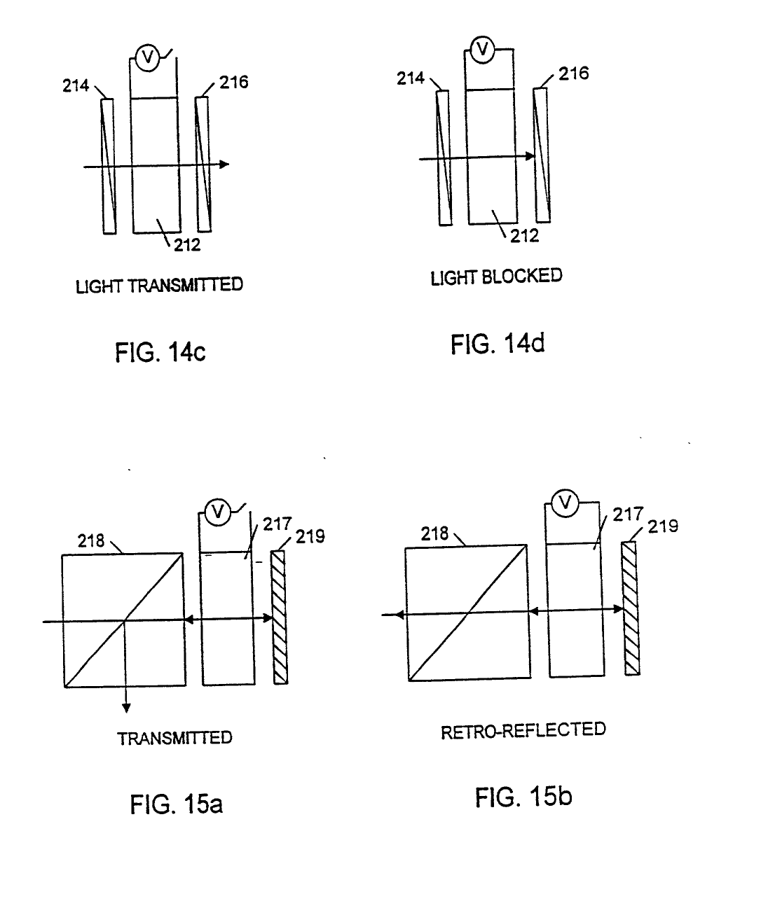

If, for example, the polarization of the incident light is at an angle of 45° with respect to the optic axis 210 of a half-wave plate 212, as shown in FIG. 14a, the plane polarization will be preserved, but the polarization of the wave exiting the plate will be shifted by 90°. Thus, referring now to FIG. 14b and 14c, where the half-wave 20 plate 212 is placed between cross polarizers 214 and 216, the incident light will be transmitted. If an appropriate switching voltage is applied, as shown in FIG. 14d, the polarization of the light is not rotated and the light will be blocked by the second polarizer.

For a quarter wave plate plane polarized light is converted to circularly polarized light. Thus, referring now to FIG. 15a, where quarter wave plate 217 is placed between a polarizing beam splitter 218 and a mirror 219, the reflected light will be reflected by the beam splitter 218. If an appropriate switching voltage is applied, as shown in FIG. 15b, the reflected light will pass through the beam splitter 30 and be retroreflected on the incident beam.

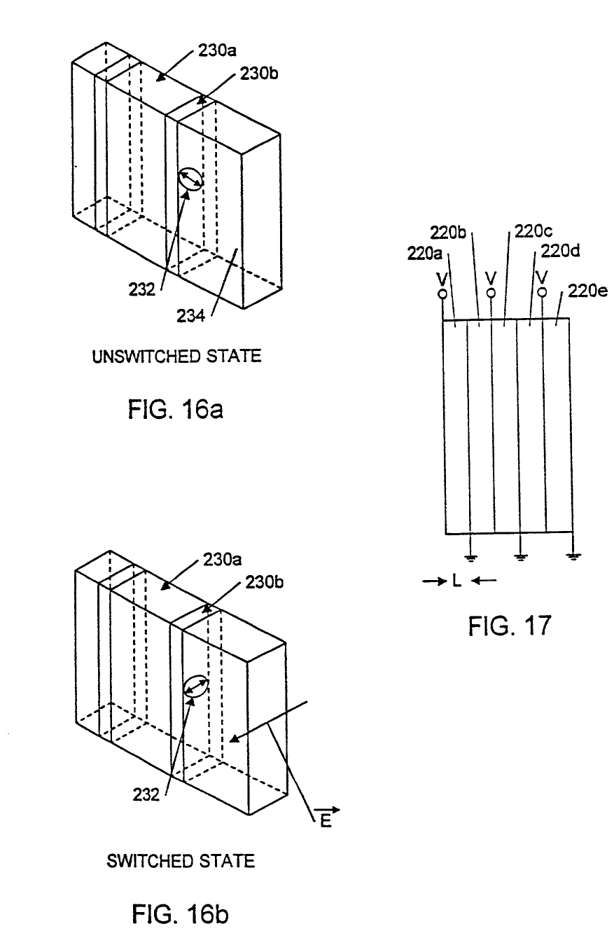

Referring now to FIG. 16a, there is shown an elevational view of a subwavelength grating 230 recorded in accordance with the above-described methods and having periodic planes of polymer channels 230a and PDLC channels 230b disposed perpendicular to the front surface 234 of grating 230. As shown in FIG. 16a, the symmetry axis 232 of the liquid crystal domains is disposed in a direction parallel to the front surface 234 of the grating and perpendicular to the periodic channels 230a and 230b of the grating 230. Thus, when an electric field E is applied across the grating, as shown in FIG. 1 5b, the symmetry axis 232 distorts and reorients in a direction along the field E, which is perpendicular to the front surface 234 of the grating and parallel to the periodic channels 230a and 230b of the grating 230. As a result, subwavelength grating 230 may be switched between a state where it changes the polarization of the incident radiation and a state in which it does not. Without wishing to be bound by any theory, it is currently believed that the direction of the liquid crystal domain symmetry 232 is due to a surface tension gradient which occurs as a result of the anisotropic diffusion of monomer and liquid crystal during recording of the grating and that this gradient causes the liquid crystal domain symmetry to orient in a direction perpendicular to the periodic planes.

As discussed in Born and Wolf, Principles of Optics, 5^{th} Ed., New York (1975) and incorporated herein by reference, the birefringence of a subwavelength grating is given by the following relation:

nₑ²−nₒ²−[(f_{PDLC})(fₚ)(n_{PDLC}²⁻ⁿₚ²)]/[f_{PDLC}n_{PDLC}²+fₚnₚ²]

Where

n=the ordinary index of refraction of the subwavelength grating;

nₑ=the extraordinary index of refraction;

n_{PDLC}=the refractive index of the PDLC plane;

nₚ=the refractive index of the polymer plane

n_{LC}=the effective refractive index of the liquid crystal seen by an incident optical wave;

f_{PDLC}=t_{PDLC}/(t_{PDLC}+t_{P})

f_{P}=t_{P}/(t_{PDLC}+t_{P})

Thus, the net birefringence of the subwavelength grating will be zero if n_{PDLC}=nₚ.

It is known that the effective refractive index of the liquid crystal, n_{LC}, is a function of the applied electric field, having a maximum when the field is zero and value equal to that of the polymer, nₚ, at some value of the electric field, E_{MAX}. Thus, by application of an electric field, the refractive index of the liquid crystal, n_{LC}, and, hence, the refractive index of the PDLC plane may be altered. Using the relationship set forth above, the net birefringence of a subwavelength grating will be a minimum when n_{PDLC} is equal to nₚ, i.e. when n_{LC}=nₚ. Therefore, if the refractive index of the PDLC plane may be matched to the refractive index of the polymer plane, i.e. n_{PDLC}=n_{P}, by the application of an electric field, the birefringence of the subwavelength grating may be switched off.

The following equation for net birefringence, i.e. |Δn|=|nₑ−nₒ, follows from the equation given in Born and Wolf (reproduced above):

Δn=−[(f_{PDLC})(fₚ)(n_{PDLC}²−nₚ²)]/[2n_{AVG}(f_{PDLC}n_{PDLC}²+fₚnₚ²)]

where n_{AVG}=(nₑ+nₒ)/2

Furthermore, it is known that the refractive index of the PDLC plane n_{PDLC} is related to the effective refractive index of the liquid crystal seen by an incident optical wave, n_{LC}, and the refractive index of the surrounding polymer plane, nₚ, by the following relation:

N_{PDLC}=nₚ+f_{LC}[n_{LC}−nₚ]

Where f_{LC} is the volume fraction of liquid crystal dispersed in the polymer within the PDLC plane, f_{LC}=[V_{LC}/(V_{LC}+V_{P})].

By way of example, a typical value for the effective refractive index for the liquid crystal in the absence of an electric field is n_{LC}=1.7, and for the polymer layer nₚ,=1.5. For the grating where the thickness of the PDLC planes and the polymer planes are equal (i.e. t_{PDLC}=t_{P}, f_{PDLC}=0.5=fₚ) and f_{LC}=0.35, the net birefringence, Δn, of the subwavelength grating is approximately 0.008. Thus, where the incident light has a wavelength of 0.8 μm, the length of the subwavelength grating should be 50 μm for a half-wave plate and a 25 μm for a quarter-wave plate. Furthermore, by application of an electric field of approximately 5 V/μm, the refractive index of the liquid crystal may be matched to the refractive index of the polymer and the birefringence of the subwavelength grating turned off. Thus, the switching voltage, Vₙ, for a half-wave plate is on the order of 250 volts, and for a quarter-wave plate approximately 125 volts.

By applying such voltages, the plates may be switched between the on and off (zero retardance) states on the order of microseconds. As a means of comparison, current Pockels cell technology may be switched in nanoseconds with voltages of approximately 1000-2000 volts, and bulk nematic liquid crystals may be switched on the order of milliseconds with voltages of approximately 5 volts.

In an alternative embodiment, as shown in FIG. 17, the switching voltage of the subwavelength grating may be reduced by stacking several subwavelength gratings 220a-220e together, and connecting them electrically in parallel. By way of example, it has been found that a stack of five gratings each with a length of 10 μm yields the thickness required for a half-wave plate. It should be noted that the length of the sample is somewhat greater than 50 μm, because each grating includes an indium-tin-oxide coating which acts as a transparent electrode. The switching voltage for such a stack of plates, however, is only 50 volts.

Subwavelength gratings in accordance with the this description are expected to find suitable application in the areas of polarization optics and optical switches for displays and laser optics, as well as tunable filters for telecommunications, colorimetry, spectroscopy, laser protection, and the like. Similarly, electrically switchable transmission gratings have many applications for which beams of light must be deflected or holographic images switched. Among these applications are: Fiber optic switches, reprogrammable N×N optical interconnects for optical computing, beam steering for laser surgery, beam steering for laser radar, holographic image storage and retrieval, digital zoom optics (switchable holographic lenses), graphic arts and entertainment, and the like.

A switchable hologram is one for which the diffraction efficiency of the hologram may be modulated by the application of an electric field, and may be switched from a fully on state (high diffraction efficiency) to a fully off state (low or zero diffraction efficiency). A static hologram is one whose properties remain fixed independent of an applied field. In accordance with this description, a high contrast static hologram may also be created. In this variation of this description, the holograms are recorded as described previously. The cured polymer film is then soaked in a suitable solvent at room temperature for a short duration and finally dried. For the liquid crystal E7, methanol has shown satisfactory application. Other potential solvents include alcohols such as ethanol, hydrocarbons such as hexane and heptane, and the like. When the material is dried, a high contrast status hologram with high diffraction efficiency results. The high diffraction efficiency is a consequence of the large index modulation in the film (Δn˜0.5) because the second phase domains are replaced with empty (air) voids (n˜1).

Similarly, in accordance with this description a high birefringence static subwavelength wave-plate may also be formed. Due to the fact that the refractive index for air is significantly lower than for most liquid crystals, the corresponding thickness of the half-wave plate would be reduced accordingly. Synthesized wave-plates in accordance with this description may be used in many applications employing polarization optics, particularly where a material of the appropriate birefringence that the appropriate wavelength is unavailable, too costly, or too bulky.

The term polymer dispersed liquid crystals and polymer dispersed liquid crystal material includes, as may be appropriate, solutions in which none of the monomers have yet polymerized or cured, solutions in which some polymerization has occurred, and solutions which have undergone complete polymerization. Those of skill in the art will clearly understand that the use herein of the standard term used in the art, polymer dispersed liquid crystals (which grammatically refers to liquid crystals dispersed in a fully polymerized matrix) is meant to include all or part of a more grammatically correct prepolymer dispersed liquid crystal material or a more grammatically correct starting material for a polymer dispersed liquid crystal material.

2. System and Method For Modulating the Intensity of Light

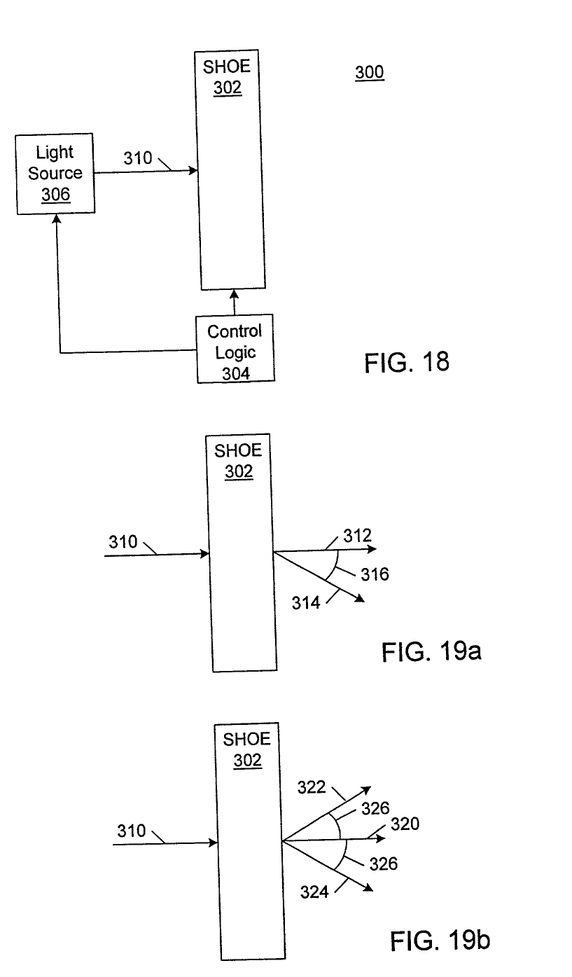

FIG. 18 is a block diagram showing a light intensity modulator system 300 employing the present invention. System 300 in FIG. 18 includes a switchable holographic optical element (SHOE), 302, a control circuit 304, and a light source 306. SHOE 302 is electrically coupled to control circuit 204, and receives therefrom one or more variable control voltages. SHOE 302 is also positioned to receive an input light 310 from light source 306.

Light source 306 may or may not be electrically coupled to receive controlling signals from control circuit 304. FIG. 18 shows light source 306 electrically coupled to control circuit 304, it being understood that coupling between light source 306 and control circuit 304, is not necessary in several embodiments of the present invention.

In one embodiment, SHOE 302 includes one or more switchable holograms recorded in a medium described above. The switchable hologram may be either a thick phase or a thin phase switchable hologram. Thick phase holograms are often referred to as Bragg or volume type holograms. Thin phase holograms are often referred to the holograms that conform to the Raman Nath regime. Further, the switchable hologram of SHOE 302 may be either a reflective or a transmissive type hologram. Reflective type holograms receive input light at one surface and produce refracted light at a second opposite facing surface.

In general, a switchable hologram operates in either an active state or an inactive state, depending upon the magnitude of the variable control voltage supplied thereto. In the active state, a switchable hologram diffracts an input light. In the inactive state, a switchable hologram transmits the input light substantially unaltered and without diffraction such that the switchable hologram resembles a transparent medium such as glass. In the active state, the switchable hologram may diffract one of the primary colors of the visible bandwidth (e.g., red, green, blue) while transmitting the remaining primary colors without diffraction or blocking the remaining primary colors from further transmission.

FIG. 19a illustrates operational aspects of SHOE 302 having a thick phase switchable hologram recorded therein. FIG. 19b shows operational aspects of SHOE 302 having a thin phase switchable hologram recorded therein. The switchable holograms recorded in SHOE 302 of FIGS. 19a and 19b are shown operating in the active state. More particularly, the thick phase hologram recorded in SHOE 302 of FIG. 19a receives and diffracts input light 310 to produce a zero order diffracted output light 312 and a first order diffracted output light 314. Zero order diffracted output light 312 may be referred to as first output light 312, while first order diffracted output light 314 may be referred to as second output light 314. Output lights 312 and 314 define a non-zero angle 316 therebetween. The thin phase switchable hologram of SHOE 302 in FIG. 9b receives and diffracts input light 310 to produce zero order diffracted output light 320, positive first order diffracted output light 322, and negative first order diffracted light 324. Non-zero angle 326 is defined between the zero order diffracted light 320 and the positive and negative first order diffracted output lights 322 and 324. The system of FIG. 18 will be described with reference to SHOE 302 having a thick phase (i.e., Bragg) transmissive hologram recorded therein, it being understood that the present invention should not be limited thereto.

As noted above with respect to FIG. 19a, the emerging light will have two main components, zero order diffracted output light 312, which propagates in the direction of input light 310 and first order diffracted light 314 which satisfies the Bragg diffraction relation, and will normally carry the bulk of the diffracted light energy. There may be higher order diffraction output components, representing a small proportion of the total diffracted light energy. If the thick phase hologram has close to maximum theoretical efficiency, the problem of dealing with zero order output light is largely eliminated. At lower efficiencies, the zero order output light 312 will be present. Thick phase holograms offer higher diffractive efficiencies up to a theoretical maximum of 100%. There are stray light considerations, which point to the use of thick phase holograms. Thin phase holograms, as noted above with respect to FIG. 19b, give rise to the positive and negative diffracted orders in addition to the zero order. The maximum diffraction efficiency in the first order for thin phase holograms is 33.8% for a sinusoidal profile and 40.4% for a square profile. In practice only one of the output lights are typically used. The unused output light or lights may present stray light problems.

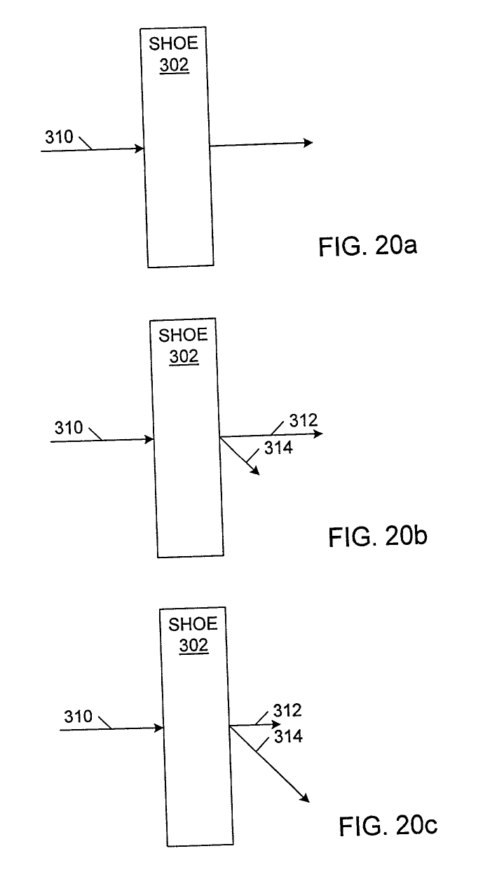

As noted above, switchable holograms operate in either the active or inactive state in response to the magnitude of the variable control voltage supplied thereto. FIGS. 20a-20c illustrate operational aspects of the thick phase transmissive type switchable hologram recorded in the SHOE 302 of FIG. 19a. In FIG. 20a, SHOE 302 operates in the inactive state and transmits input light 302 without substantial alteration and diffraction. In FIGS. 20b and 20c, SHOE 302 operates in the active state. In the active state, SHOE 302 modulates the intensity of output lights 312 and 314 as a function of the variable control voltage magnitude generated by control circuit 304. For example, the intensity of first output light 312 is directly related to the magnitude of the variable control voltage while the intensity of the second output light 314 is indirectly related to the magnitude of the variable control voltage. In FIG. 20b, SHOE 302 receives a first variable control voltage having a first magnitude and in FIG. 20c, SHOE 302 receives a second variable control voltage having a second magnitude. The first magnitude is greater than the second, and thus, the intensity of the first output light 312 in FIG. 20b is greater than the intensity of the first output light 312 in FIG. 20c. In contrast, the intensity of the second output light 314 in FIG. 20b is less than the intensity of the second output light 314 in FIG. 20c. Essentially, as will be more fully described below, the control voltage provided to the SHOE 302 is varied such that there is continuous change in the refractive index modulation of the recorded switchable hologram, which in turn gives rise to a variable diffraction efficiency, or in other words, a continuous transfer of energy between the zeroth order (i.e., first ) output light 312 and the first order (second) output light 314. In principle, either the first or second output lights 312 or 314 respectively, could provide the needed modulated output.

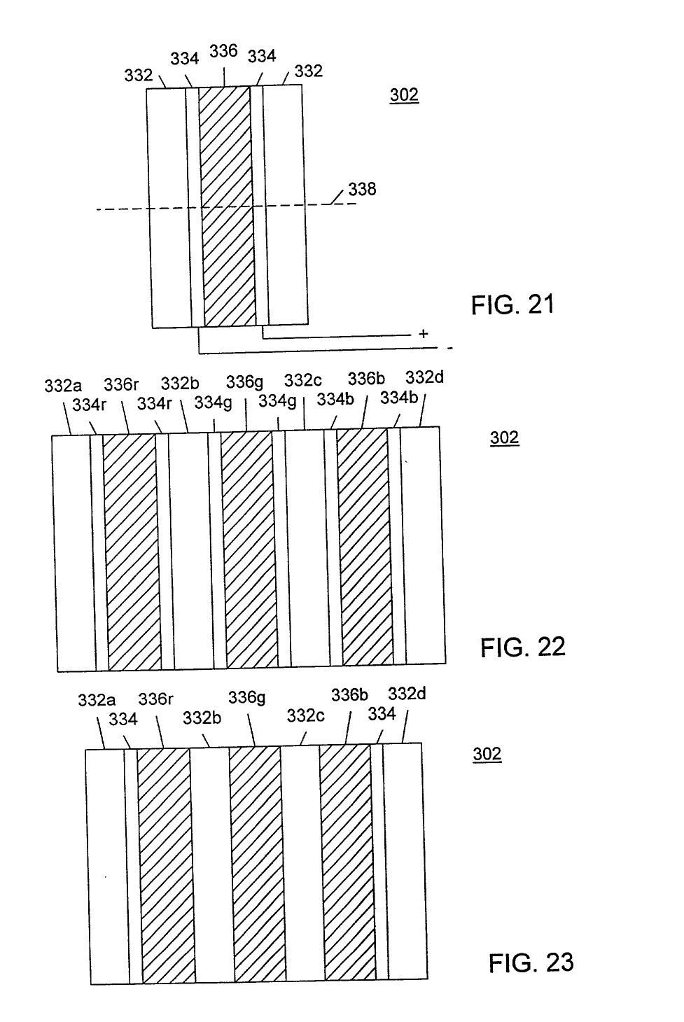

FIG. 21 shows a cross-sectional view of one embodiment of a monochromatic SHOE 302 shown in FIG. 18. SHOE 302 in FIG. 21 includes a pair of substantially transparent and electrically nonconductive layers 332, a pair of substantially transparent and electrically conductive layers 334, and a switchable hologram layer or medium 336 formed, in one embodiment, from a polymer dispersed liquid crystal material described above. The switchable holographic layer or medium 336 records the switchable hologram. In one embodiment, substantially transparent, electrically nonconductive layers 332 are formed from glass while the electrically conductive, substantially transparent layers 334 are formed from indium tin oxide (ITO). An anti-reflection coating (not shown) may be applied to selected surfaces of the layered SHOE 302 including the example ITO and glass layers, to improve the overall transmission efficiency of the optical element and to reduce stray light. As shown in FIG. 21, all layers 332-336 are arranged like a stack of pancakes on a common axis 338.

Layers 332-336 of SHOE 302 shown in FIG. 21 may have substantially thin cross-sectional widths thereby providing a substantially thin aggregate in cross section. More particularly, switchable holographic layer 336 may have a cross-sectional width of 5-12 microns (the precise width depending on the spectral bandwidth and required diffraction efficiency). The glass layers 332 may have a cross-sectional width of 0.4 -0.8 millimeters. Obviously, ITO layer 334 must be substantially thin to be transparent.

In one embodiment, ITO layers 334 are coupled to the control circuit 304 and receive the variable control voltage provided therefrom. As noted above, the switchable hologram recorded in layer 336 is activated or deactivated depending upon the magnitude of the variable control voltage applied between ITO layers 334. When a sufficient electric field exists between ITO layers 334 by virtue of a voltage applied between ITO layers 334, the switchable hologram established therein is said to operate in the inactive state. As the variable control voltage is lowered, the switchable hologram recorded in layer 336 is eventually activated such that it diffracts input light that satisfies the Bragg diffraction angle of the recorded switchable hologram. Once in the active state, a continued decrease in the magnitude of the variable control voltage changes the diffractive index modulation of the recorded hologram which, in turn, gives rise to the variable diffraction efficiency described above.

The SHOE 302 illustrated in FIG. 21 is used in a system 300 for modulating the intensity of a monochromatic light. The SHOE 302 shown in FIG. 21 may find application in systems used for illuminating displays with variable intensity output light 312 or 314 as shown in FIG. 18. Additionally, the SHOE 302 shown in FIG. 21 could be used in a communication system for modulating the intensity of light transmitted over an optical medium where the intensity of the transmitted light relates to data signals received by the control circuit 304.

FIGS. 22 and 23 show embodiments of a polychromatic SHOE 302 employable in the system of FIG. 18. The SHOE 302 shown in FIG. 22 includes several substantially transparent and electrically nonconductive layers 332a-332d, several substantially transparent and electrically conductive layers 334r-334b, and several switchable hologram layers 336r-336b formed, in one embodiment, from the polymer dispersed liquid material described above. Like the layers shown in FIG. 21, the electrically nonconductive layers 332a-332b may be formed from glass while the electrically conductive, substantially transparent layers 334r-334b may be formed from ITO. An anti-reflection coating (not shown) may be applied to selected surfaces to improve the overall transmission efficiency and to reduce stray light.

The switchable holographic layers 336r-336b each record a switchable hologram configured to diffract a distinct band of visible light when activated. When inactive, each of the switchable holograms transmits all bands of visible light without alteration or diffraction. The switchable hologram recorded in layers 336r-336b are optimized to diffract red, green, and blue bandwidth visible light, respectively, when activated.

Each of the switchable layers 336r-336b is sandwiched between a pair of ITO layers. In the configuration shown in FIG. 22, any one or all of the holographic layers 336r-336b can be activated with one or several variable control voltages provided by control circuit 304. When SHOE 302 of FIG. 22 is used in the system shown in FIG. 18, light source 306 may be defined as a white light source capable of simultaneously producing red, green, and blue bandwidth light. System 300 shown in FIG. 18 using such a white light source 306 and the SHOE 302 shown in FIG. 22, is capable of outputting first and second lights 312 and 314 of one of the primary visible bandwidths (e.g., red, green, or blue). Alternatively, the SHOE 302 shown in FIG. 22 operating in the system shown in FIG. 18 with a white light source 306, is capable of outputting first and second output lights 312 and 314 which contain a mixture of the primary color bandwidths. In either case, the intensities of the output lights 312 and 314 can be modulated in accordance with the magnitudes of the variable control voltages provided by control circuit 304 to the ITO layers 334r-334b when SHOE 302 is operating in the active state.

SHOE 302 shown in FIG. 23 is likewise capable of producing first and second modulated output lights 312 and 314 which contain one or more of the primary colors of the visible bandwidth. The SHOE shown in FIG. 23 finds application in the system 300 shown in FIG. 18 with light source 306 defined as three light sources, each one of which is capable of generating one of the primary colors of visible light (e.g., red, blue, or green). The SHOE 302 shown in FIG. 23 includes three switchable holographic layers 336r-336b, each one of which is configured to diffract a distinct primary color of visible light when activated. Like the switchable holographic layers shown in FIG. 22, layers 336r-336b record switchable holograms which, when operating in the inactive state, transmits substantially all visible light without substantial alteration and diffraction. The SHOE 302 shown in FIG. 23 includes four substantially transparent and electrically non-conductive layers 332a-332d (e.g., glass) in addition to a pair of substantially transparent and electrically conductive layers 334 (e.g., ITO). The ITO layers 334 receive the variable control voltage from control circuit 304 and act to establish a uniform electric field across all three of the switchable layers 336b thereby simultaneously activating the switchable holographs recorded therein. However, with light source 306 comprised of three distinct sources of red, green, and blue bandwidth light, the SHOE 302 shown in FIG. 23 is capable of generating modulated first and second output lights 312 and 314 which are limited to one of the primary bandwidths so long as only one of the three distinct sources of light are activated by control circuit 304.

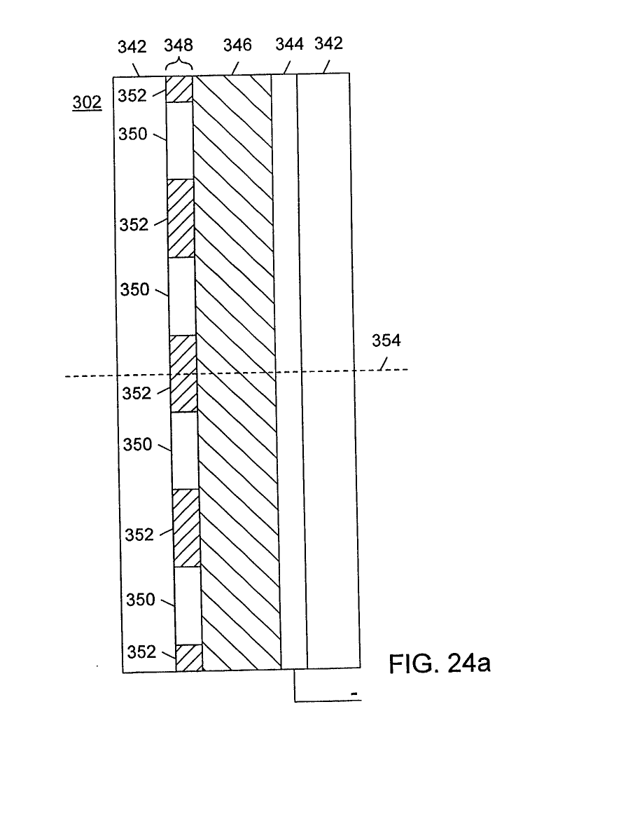

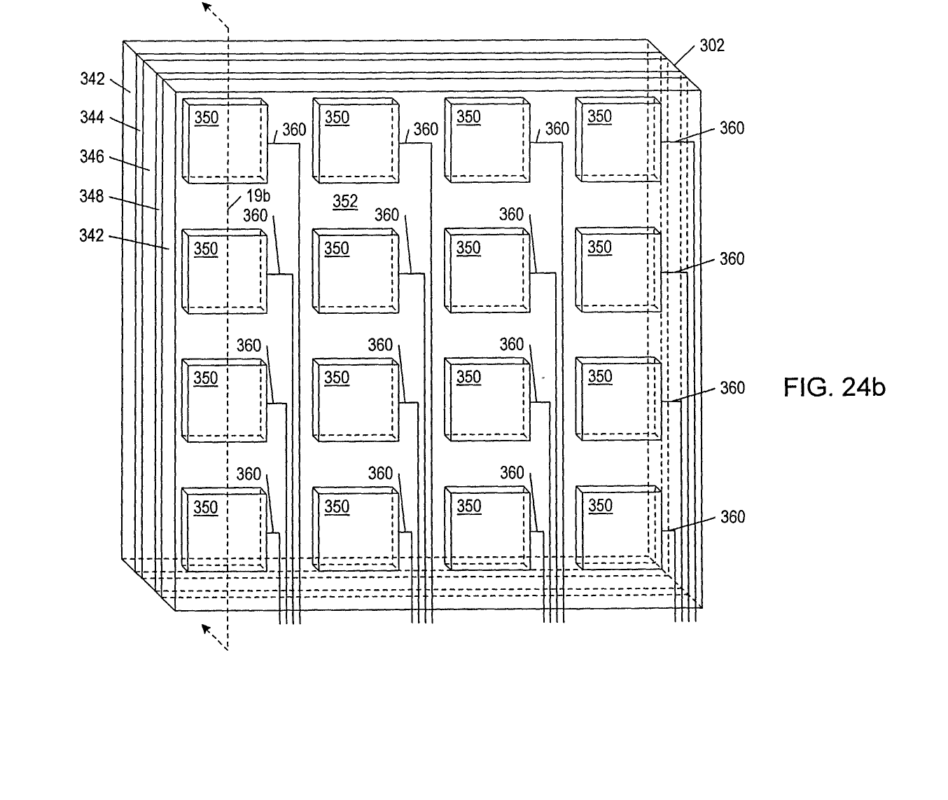

The SHOE 302 shown in FIGS. 21-23 may be employed in LIM systems for modulating the intensity light needed to, for example, illuminate an object with one or more bandwidths of color. The SHOEs shown in FIGS. 24-28 can be used in SLM systems or in diffractive display systems. The SHOEs 302 shown in FIGS. 21-23 employ ITO layers 334 which activate the entire switchable hologram recorded in layers 336, the SHOE 302 shown in FIGS. 24-28 employ an array of substantially transparent and electrically conductive electrodes formed from, for example, ITO which control light diffraction in subareas of the switchable hologram recorded in a switchable holographic layer in accordance with variable control signals provided by control circuit 304.

FIGS. 24a and 24b show an example of a monochromatic SHOE 302 which can be employed in the system 300 shown in FIG. 18 as a diffractive display. FIG. 24a is a cross-sectional view of the SHOE 304 shown in FIG. 24b. In FIGS. 24a and 24b, SHOE 302 includes a pair of substantially transparent and electrically nonconductive layers 342, a transparent and electrical conductive layer 344, a switchable holographic layer 346 formed, in one embodiment, from a polymer dispersed liquid crystal material described above, and a layer 348 which includes an array of substantially transparent and electrically conductive electrodes 350 electrically isolated by an electrically nonconductive isolator 352. In one embodiment, the substantially transparent, electrically nonconductive layers 342 are formed from glass while the electrically conductive, substantially transparent layer 344 and electrodes 350 of layer 348 are formed from ITO. Anti-reflection coatings may be provided on selected surfaces.

As shown more particularly in FIG. 24b, each ITO electrode is isolated and capable of receiving an individual variable control voltage from control circuit 304 of FIG. 18 via a thin conductive line 360. Thus, control circuit 304 is capable of activating or deactivating any subarea of the switchable hologram recorded in layer 346 directly underneath an individual electrode 350. In other words, control circuit 304 is capable of modulating the refractive index of the switchable hologram subarea directly underneath an individual electrode 350. The variable control signals generated by circuit 304 may be produced in response to control circuit 304 receiving a frame of image signals.

FIG. 24b shows a 4×4 array of ITO electrodes 350 with a substantial distance between each field filled by electrically nonconductive isolator. It is to be noted that the SHOE 302 shown in FIG. 24b could be implemented with an array having a greater number of rows and columns of ITO electrodes 350. Further, FIG. 24b shows a large spacing between ITO conductors such that conductive lines 360 can be easily identified. In practice, the spacing between ITO electrodes 350 will not be so large.

With continuing reference to FIG. 24a and FIG. 24b, ITO layer 344 is generally coupled to one terminal (i.e., ground) of the control circuit 304. Accordingly, when one of the ITO electrodes 350 is activated by a variable control voltage from control circuit 304, a corresponding electric field is established within the subarea of switchable holographic layer 356 underlying the electrode. If the field is great enough, the hologram within the subarea will be deactivated.

Switchable holographic layer 346 (and 336 of FIGS. 21-23) record holograms, in one embodiment, using the techniques described above. In one embodiment, a high diffraction efficiency and fast rate at which the optical elements can be switched between active and inactive states, characterize the resulting hologram. Additionally, the resulting holograms are characterized by a fast change in refractive index when the holograms are operating in the active state. In the polymer dispersed liquid crystal (PDLC) material formed embodiment of layers 336 and 346, the recorded holograms can be switched from a diffraction state to a transmission state with the creation and illumination of the electric field mentioned above. This material has been found to produce acceptable switching efficiencies at a few volts per micron of holographic layer thickness, potentially as low as 1 volt per micron thickness. Holograms recorded in the material described above may have switching times less than 20 microseconds. Ideally, the holograms would be Bragg type in order to achieve high diffraction efficiency.

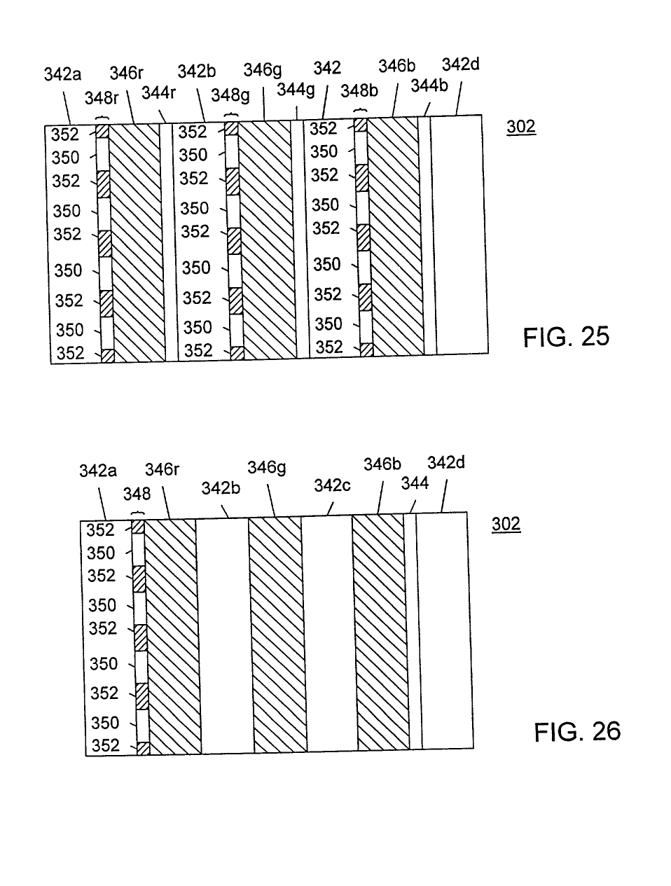

The SHOE 302 described in FIGS. 24a and 24b enable, for example, a diffractive display capable of generating a monochromatic image. In use, the SHOE 302 shown in FIG. 24a and 24b is capable of generating the monochromatic image as a function of variable control voltages provided by control circuit 304 which operates, in turn, in response to receiving a frame of image signals. Clearly, it is desirable to produce colored images. The SHOE shown in FIGS. 25-28 are capable of generating such colored images.

FIG. 25 shows three switchable holographic layers 346r-346b, each one of which records a switchable hologram that operates to diffract a distinct primary color of the visible bandwidth when activated and which transmits all visible light without alteration or diffraction when operating in the inactive state. The SHOE 302 in FIG. 25 also includes several substantially transparent and electrically nonconductive layers 342a-342d, several substantially transparent and electrically conductive layers 344r-344b, and layers 348r-348b, each of which comprises an array of substantially transparent and electrically conductive electrodes 350 electrically isolated by an electrical nonconductor 352. In one embodiment, layers 342 may be formed from glass while layers 344 and electrodes 350 may be formed from ITO.

Each ITO electrode 350 in each layer 348r-348b, receives a variable control voltage from control circuit 304. Control circuit 304 generates the variable control voltages in response to receiving a frame of color image signals. The ITO electrodes 350 in each layer 348r-348b are coupled to control circuit 304 via thin conductive lines 360. In one embodiment, the array of electrodes in layers 348r-348b are sequentially activated and deactivated thereby activating deactivating underlying portions of adjacent holograms. The switchable holographic layers respond quickly to a change in voltage to individual electrodes 350 thus allowing the sequential activation and deactivation of electrode rays within layers 348r-348b to occur very quickly. The speed enables light diffracted by each of the holographic layers 346r-346b to be eye integrated by a viewer.

SHOE 302 shown in FIG. 25 can be employed as a diffractive display in the system shown in FIG. 18. In one embodiment of such system, light source 306 may be defined as white light source capable of simultaneously generating the three primary colors of visible light. The operation of such a system is similar to the system described with reference to FIG. 22. White light 310 inputted to SHOE 302 of FIG. 22 is diffracted by one or more subareas of a single switchable hologram recorded in layers 336r, 336g, or 336b, which is adjacent to one or more activated electrodes 350 in layers 448r, 448g, or 448b. Alternatively, one or more subareas of switchable holograms recorded in two of the three layers 346r-346b may be activated by corresponding electrodes 350.

In one embodiment of the invention, only one set of electrodes associated with each of the holograms is enabled at any given time. With the electrodes enabled, a selected amount of input light can be diffracted into the first output light and towards a user, while light diffracted into the second output light is directed such that it cannot be seen by the user. The electrodes corresponding to each of the three holograms are sequentially enabled such that a selected amount of red, green and blue light is directed towards a user for each electrode location. Provided that the rate at which the holograms are sequentially enabled is faster than the response time of a human eye, a color image will be created in the viewer's eye due to the integration of the red, green and blue monochrome images created by each of the switchable holograms recorded in the holographic layers.

FIG. 26 shows yet another embodiment of a SHOE 302 which can be employed as a diffractive display in system 300. Like the SHOE 302 shown in FIG. 25, the SHOE 302 shown in FIG. 26 includes three switchable holographic layers 346r-346b each of which records a switchable hologram that in the active mode diffracts a distinctive bandwidth of visible light. Thus, the switchable hologram recorded in layer 346r diffracts red bandwidth light when active, the switchable hologram recorded in layer 346g diffracts green bandwidth light when activated, and a switchable hologram recorded in 346b diffracts blue bandwidth light when active. Additionally, each subarea of the switchable holograms recorded in 346r-346b is defined by a refractive index which can be modulated quickly in response to a change in voltage on an individual electrode 350. The SHOE 302 shown in FIG. 26 also includes substantially transparent and electrically nonconductive layers 342a-342b, a substantially transparent and electrically conductive layer 344 and layer 348 which includes an array of substantially transparent and electrically conductive electrodes 350 electrically isolated by an electrical nonconductor isolator 352. In one embodiment, the nonconductive layers 342a-342d may be formed from glass, the conductive layer 344 may be formed from ITO, and the electrodes 350 may be formed from ITO. Anti-reflection coatings, not shown, may be provided on selected surfaces of the layers 306 to improve the overall transmission efficiency of the SHOE 302.

Each of the electrodes 350 in the array shown in FIG. 26 is electrically coupled and configured to receive an individual variable control voltage from the control circuit 304 shown in FIG. 18. Control circuit 304 generates the variable control voltages in response to receiving a frame of image signals. The control circuit 304 may include a digital-to-analog converter that allows a processor (not shown) to write a digital value to each electrode location and to have that digital value converted to a corresponding analog variable control voltage that controls the amount of light diffracted into the first or second output light. Depending upon the number of electrodes in the display, the control circuit may be designed to simultaneously address all the electrodes or may write to the electrodes in a raster fashion. The light source 306 shown in FIG. 18, when used in connection with the SHOE 302 shown in FIG. 26, ideally contains three distinct light sources, each one of which emits a primary color, (e.g., red, green, or blue), of the visible bandwidth light. Generally, the three distinct light sources in one embodiment will be sequentially activated thereby providing SHOE 302 of FIG. 26 with sequential beams of red, green, and blue input light 310. The three separate light sources of light source 306 emit light in response to control signals provided by control circuit 304. The control signals provided to the light source are timed so that light of one bandwidth is emitted from source 306 while the holographic layer 346 configured to diffract light of the same bandwidth is activated.

Alternatively, all three superimposed switchable holograms may be recorded in a single holographic layer. In this embodiment, three separate fringe patterns are provided for the superimposed holograms corresponding to red, green and blue wavelengths. The separate fringe patterns have distinct angular acceptance characteristics, such that a ray of light which is diffracted by one set of fringes does not also satisfy the diffraction condition for the other two fringe patterns.

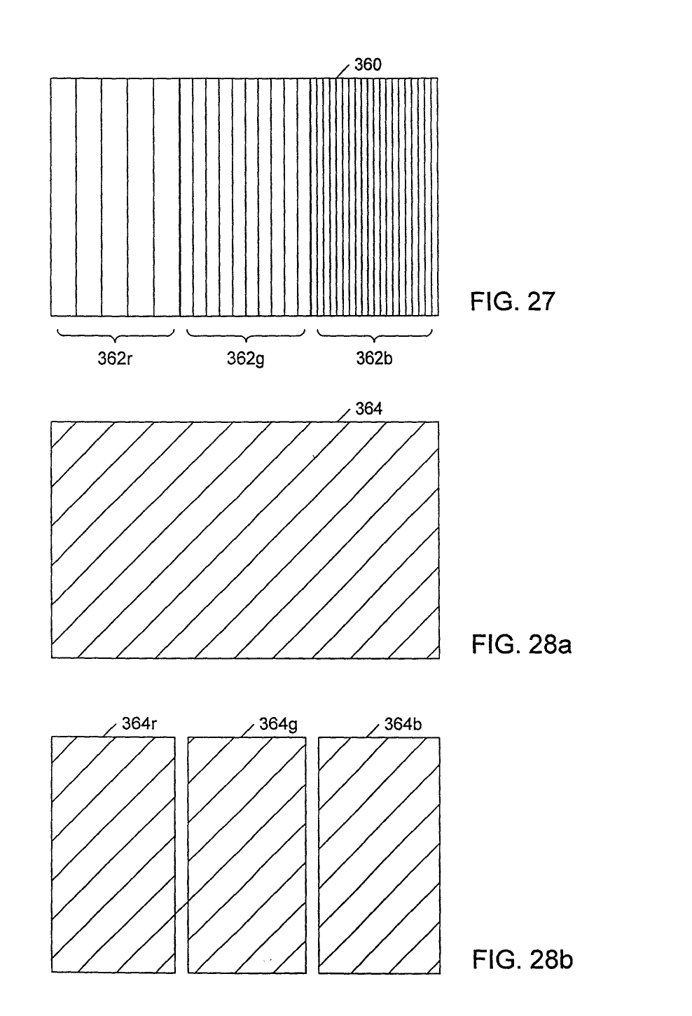

FIG. 27 shows a plain view of a portion of a composite hologram which has three distinct switchable holograms 362r, 362g, and 362b recorded therein. The portion shown in FIG. 27 represents one of the two-dimensional array of portions of the composite and define one pixel in a polychromatic diffractive display employable in the system shown in FIG. 18. Each sub-hologram 362r, 362g, and 362b, has a different grating pitch such that light of distinct visible bandwidths (e.g., red, green, and blue) are defined by a unique range of diffraction angles. Red light would have the largest pitch and blue the narrowest.

FIGS. 28a and 28b each represent electrodes formed of visibly transparent and electrically conductive material, such as ITO, which are sized to fit over the holographic layer portion 360 set forth in FIG. 27. Electrode 364 shown in FIG. 28a receives a variable control voltage from control circuit 304 shown in FIG. 18. The voltage operates to activate or deactivate all three of the switchable hologram portions shown in FIG. 27.

The electrodes 364r-364b in FIG. 28b are also sized to fit over aligned with the holograms 362r, 362g, and 362b, respectively, of the switchable holographic layer portion shown in FIG. 27. Each of the electrodes 364r-364b receives a variable control voltage from control circuit 304 to activate or deactivate the corresponding switchable holograms 362r-362b shown in FIG. 27.

In each instance in which the SHOE 302 shown in FIG. 18 is defined as a diffractive display, control circuit 304 provides variable control voltages to electrodes which causes an underlying one or more switchable electrodes to diffract one or more primary colors of the visible bandwidth. The diffracted light is outputted in first and second output lights 312 and 314. A viewer who is line with one of the first and second output lights views the diffracted light. An array of selectively diffracting subareas of one or more switchable holograms presents an image to the viewer. As noted above, the variable control voltage for each electrode in the diffractive display can be individually controlled thereby enabling a two-dimensional image to be created by controlling the amount of light or brightness produced by output lights 312 or 314.

We claim:

1. An image projection system comprising
a first set of red, green, and blue light sources for generating first red, green, and blue bandwidth lights, respectively;
a first set of red, green, and blue bandwidth sensitive switchable holographic optical elements;
a circuit coupled to the first set of red, green, and blue bandwidth sensitive switchable holographic optical elements, wherein the circuit is configured to receive first red, green, and blue pixel component digital signals, wherein the control circuit generates first red, green, and blue pixel component analog voltages in response to receiving the first red, green, and blue pixel component digital signals, respectively, wherein the magnitudes of the first red, green, and blue pixel component analog voltages depend on the first red, green, and blue pixel component digital signals, respectively;
wherein the first set of red, green, and blue bandwidth sensitive switchable holographic optical elements diffract portions of the first red, green, and blue bandwidth lights, respectively, in response to receiving the first red, green, and blue pixel component analog voltages, respectively, wherein the diffracted portions of the first red, green, and blue bandwidth lights emerge from the first set of red, green, and blue bandwidth sensitive switchable holographic optical elements, respectively, as first red, green, and blue output lights, respectively, and wherein undiffracted portions of the first red, green, and blue bandwidth lights emerge from the first set of red, green, and blue bandwidth sensitive switchable holographic optical elements, respectively, as second red, green, and blue output lights, respectively;
wherein the intensities of the first red, green, and blue bandwidth output lights are inversely proportional to the magnitudes of the first red, green, and blue pixel component analog voltages, respectively, and wherein the intensities of the second red, green, and blue bandwidth output lights are proportional to the magnitudes of the first red, green, and blue pixel component analog voltages, respectively;
a light deflection device configured to receive the first red, green, and blue bandwidth output lights or the second red, green, and blue bandwidth output lights, wherein the light deflection device is configured to deflect the received first red, green, and blue bandwidth output lights or the received second red, green, and blue bandwidth output lights onto one of a first plurality of areas on a display surface.

2. The image projection system of claim 1 further comprising:
a second set of red, green, and blue light sources for generating second red, green, and blue bandwidth lights, respectively;
a second set of red, green, and blue bandwidth sensitive switchable holographic optical elements;
wherein the circuit is coupled to the second set of red, green, and blue bandwidth sensitive switchable holographic optical elements, wherein the circuit is configured to receive second red, green, and blue pixel component digital signals, wherein the control circuit generates second red, green, and blue pixel component analog voltages in response to receiving the second red, green, and blue pixel component digital signals, respectively, wherein the magnitudes of the second red, green, and blue pixel component analog voltages depend on the second red, green, and blue pixel component digital signals, respectively;
wherein the second set of red, green, and blue bandwidth sensitive switchable holographic optical elements diffract portions of the second red, green, and blue bandwidth lights, respectively, in response to receiving the second red, green, and blue pixel component analog voltages, respectively, wherein the diffracted portions of the second red, green, and blue bandwidth lights emerge from the second set of red, green, and blue bandwidth sensitive switchable holographic optical elements, respectively, as third red, green, and blue output lights, respectively, and wherein portions of the second red, green, and blue bandwidth lights which are not diffracted emerge from the second set of red, green, and blue bandwidth sensitive switchable holographic optical elements, respectively, as fourth red, green, and blue output lights, respectively;
wherein the intensities of the third red, green, and blue bandwidth output lights are inversely proportional to the magnitudes of the second red, green, and blue pixel component analog voltages, respectively, and wherein the intensities of the fourth red, green, and blue bandwidth output lights are proportional to the magnitudes of the second red, green, and blue pixel component analog voltages, respectively;
wherein the light deflection device is configured to receive the third red, green, and blue bandwidth output lights or the fourth red, green, and blue bandwidth output lights, wherein the light deflection device is configured to deflect the received third red, green, and blue bandwidth output lights or the received fourth red, green, and blue bandwidth output lights onto one of a second plurality of areas on the display surface.

3. The image projection system of claim 2 wherein the light deflection device is configured to deflect the received first red, green, and blue bandwidth output lights or the received second red, green, and blue bandwidth output lights while the light deflection device deflects the received third red, green, and blue bandwidth output lights or the received fourth red, green, and blue bandwidth output lights.
